(19) United States
(12) Patent Application Publication
(10) Pub. No.: US 2015/0170382 A1
(43) Pub. Date: Jun. 18, 2015

(54) SYSTEMS AND METHODS FOR AUTOMATIC INTERACTIVE VISUALIZATIONS

(71) Applicant: Sanjay Bhatia, Atlanta, GA (US)

(72) Inventor: Sanjay Bhatia, Atlanta, GA (US)

(73) Assignee: Izenda, Inc., Atlanta, GA (US)

(21) Appl. No.: 14/627,536

(22) Filed: Feb. 20, 2015

Related U.S. Application Data
(63) Continuation-in-part of application No. 12/907,184, filed on Oct. 19, 2010, now Pat. No. 8,990,258.

(51) Int. Cl. G06T 11/20; G06Q 40/00

(52) U.S. Cl. CPC G06T 11/20; G06Q 40/00

(57) ABSTRACT

Systems and methods for interactive visualizations include receiving a selection of data through the reporting system, wherein the data is contained in a database with the reporting system interfacing the database; determining an associated visualization for the selected data based on heuristics, wherein the heuristics are a set of rules used to determine the associated visualization in a manner that is most appropriate for visual analytics given the selected data; and creating and displaying the associated visualization.

### CROSS-REFERENCE TO RELATED APPLICATIONS

The present non-provisional patent application is a continuation-in-part of U.S. patent application Ser. No. 12/907,184, filed Oct. 19, 2010, and entitled “SELF-SERVICE DATABASE REPORTING SYSTEMS AND METHODS,” the contents of which are incorporated by reference herein.

### FIELD OF THE DISCLOSURE

The present disclosure relates generally to data reporting and analytic systems and methods. More particularly, the present disclosure relates to systems and methods for automatic interactive visualizations.

### BACKGROUND OF THE DISCLOSURE

Data analytics is a process of inspecting, cleaning, transforming, and modeling data with the goal of discovering useful information, suggesting conclusions, and supporting decision-making Data analysis has multiple facets and approaches, encompassing diverse techniques under a variety of names, in different business, science, and social science domains. One aspect of data analytics is visualization or visual analytics. The objective of visualizations is how to clearly and efficiently communicate information related to a set of data to users via information graphics with the intent to make comparisons, understand causality, etc. That is, visualizations seeks to make complex data more accessible, understandable, and usable. In various aspects of business, organizations, and various endeavors, massive amounts of data are being collected, processed, and stored. This trend is growing exponentially with the adoption of powerful mobile devices, wearable devices, and the like. There are vast number of Line-of-business (LOB) users that seek to glean insights from associated data. An LOB (line-of-business) application is one of the set of critical computer applications that are vital to running an enterprise, such as, without limitation, accounting, supply chain management, resource planning applications, etc.

However, the typical user does not have the Information Technology (IT) expertise or the resources to employ dedicated IT resources to develop tools or custom reports. That is, the typical user does not have intimate knowledge of Structured Query Language (SQL), JavaScript, and the like. Furthermore, the typical user does not know how to properly visualize vast amounts of disparate data. i.e., the typical user does not have the expertise to make the best decisions on how to visualize data. While big data proliferates, there is a need for the typical user to mine and sift through this data with visualizations. There is a need for systems and methods for automatic interactive visualizations that do not require IT expertise on behalf of users.

### BRIEF SUMMARY OF THE DISCLOSURE

In an exemplary embodiment, systems and methods for interactive visualizations include receiving a selection of data through the reporting system, wherein the data is contained in a database with the reporting system interfacing the database; determining an associated visualization for the selected data based on heuristics, wherein the heuristics are a set of rules used to determine the associated visualization in a manner that is most appropriate for visual analytics given the selected data; and creating and displaying the associated visualization.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a reporting system which includes visual control components, content generators, analysis components, and database components;

FIG. 2 is a block diagram of a further detailed representation of the reporting system of FIG. 1 illustrating general sub-components and modules;

FIG. 3 is a network diagram of an operation of the ad-hoc reporting system of FIG. 1;

FIG. 4 is a block diagram of various levels of abstraction associated with the reporting system of FIG. 1;

FIG. 5 is a block diagram of a server which may be used in the reporting system of FIG. 1, in other systems, or standalone;

FIG. 6 is a block diagram of a mobile device, which may be used in the reporting system of FIG. 1 or the like;

FIG. 7 is a flow chart of a visualization method that can be implemented through the reporting system of FIG. 1;

FIGS. 8-20 are exemplary visualizations created through the visualization method of FIG. 7;

FIG. 21 is a logical pyramid diagram of types of users for Business Intelligence (BI) systems such as the reporting system of FIG. 1 and the visualization method of FIG. 7;

FIGS. 22-25 are various screenshots illustrate operations of the reporting system of FIG. 1 and the visualization method of FIG. 7; and

FIGS. 26-27 are an interactive sunburst visualization.

### DETAILED DESCRIPTION OF THE DISCLOSURE

In various exemplary embodiments, the present disclosure relates to systems and methods for automatic interactive visualizations. Specifically, the systems and methods provide a “one-click” or even “no-click” automatic visualization of data, through a Web browser, for users with little or no IT expertise (versus, for example, spreadsheet programs which may provide visualizations, but only after a multitude of “clicks”). The systems and methods utilize various heuristics to make decisions, in real-time, for users on how to visualize a selected data set. The systems and methods contemplate user operation over a browser, with the systems and methods abstracting SQL, JavaScript Object Notation (JSON) schema, etc. Thus, output from the user's browser session, client-generated JSON can be provided to a backend for visualizations of the data set. The systems and methods allow a user, e.g., a business user, to generate detailed visualizations in short order, with an ability to modify “on-the-fly” without requiring IT developers or IT expertise by the user. In an exemplary embodiment, the systems and methods contemplate operation as a cloud-system or “Software-as-a-Service” communicating to users and databases for visualizations. In another exemplary embodiment, the systems and methods contemplate operation as a front-end to specific database types for reporting. Other aspects are also contemplated.

With a self-service or ad-hoc reporting system, a web browser can provide a user interface to interactively connect to a plurality of database types to create, customize, and execute reports. A user can interactively create, customize, and execute reports by selecting various report elements including, for example, data sources, fields, filters, labels, charts, dashboards, and the like. These can be selected though a web site that includes an instance of a system connected to an appropriate data source. Advantageously, the ad-hoc reporting system enables users to create reports through an Internet connection, without any special software, such as web browser plug-ins, database applications, and the like, without knowledge of data access languages, such as SQL, and without direct access to a database server. The ad-hoc reporting system can directly connect to the data source through a virtual or physical network connection. It fully functions without requiring the creation of additional configuration items like catalogs, models or secondary schemas by a programmer or database administrator (DBA). That is, the ad-hoc reporting system enables end-users to securely create and customize their own reports without involving a programmer or database expert and integrates within an application's security, navigation, and appearance. An exemplary ad-hoc reporting system is Izenda Reports provided by Izenda, Inc., the assignee of the present patent application/patent (available online at www.izenda.com).

A report itself from the ad-hoc reporting system contains no data, but rather it merely includes definitions on how report outputs are generated from a database. For example, outputs can be in any binary file format, such as, for example, HyperText Markup Language (HTML), Portable Document Format (PDF), Microsoft Excel (XLS, XLSX), Microsoft Word (DOC, DOCX), Extensible Markup Language (XML), and the like. Additionally, the outputs can include multiple visual elements, such as charts, grids, tables, and the like. This report can be stored in a file system or database in a binary or text format for future execution. The ad-hoc reporting system includes a system of software components that utilize metadata analysis techniques to present a web-based user interface (UI) that significantly reduces the number and complexity of decisions a user needs to make during a report design process. Specifically, the ad-hoc reporting system includes server-side components and browser-side components working together to enable custom-generated reports from any type of database. Additionally, the ad-hoc reporting system is configured with knowledge of specific databases, such as Oracle, Microsoft SQL Server, MySQL, DB2, Sybase, Hadoop, MongoDB, and the like. This knowledge is used to allow custom generated reports without any custom development. For example, the UI is adaptive responsive to the type of database. Accordingly, the UI only presents capabilities which are tailored to the specific database type. Importantly, the web-based UI created by the ad-hoc reporting system is configured to eliminate invalid report choices thereby limiting a user to only valid choices preventing what does not work. Also, the ad-hoc reporting system utilizes the knowledge to significantly reduce the likelihood of the end user designing a report which the database cannot execute. Reports can be generated within the capabilities of the specific database. Advantageously, the end user does not need to be familiar with the limitations and capabilities of the database.

Advantageously, the ad-hoc reporting system significantly limits the levels of user training required for custom report generation. Specifically, the ad-hoc reporting system can be operated with zero additional training. Note, because some people do not think of themselves as creative, they think visualizations are someone else's job. The automation in the ad-hoc reporting system removes these limitations—visualizations are included automatically. As big data is collected, there is a need for improved visualization, but there is a lack of data science expertise. Often visualizations are needed in context. For example, a question during an important meeting could be answered with a visualization immediately rather getting back to it later.

Additionally, the ad-hoc reporting system eliminates the need for a database administrator (DBA), developer, engineer, or the like to define a secondary schema, model, or catalog which enables the solution to be deployed in a day or less, which is significantly shorter than traditional reporting systems. For example, the ad-hoc reporting system can be deployed anywhere with network connectivity. In fact, the ad-hoc reporting system does not need to be located with a database, but rather can connect through a network to both the database and various users through standard web browser connections. With the model design process removed, technical personnel are no longer required for report customizations as they can be made directly by the end user.

Generally, the ad-hoc reporting system provides a web-based report design interface, i.e. the web-based UI, which is accessed through a standard web browser configured with scripting capabilities. The web-based report design interface includes multiple visual select components that enable a user to select data sources, fields, filters, summary fields, charting elements, descriptions, titles, and other relevant report components to create a custom report without specialized software or database training. The web-based report design interface can include navigational items as our known in the art, such as tables, pages, panels, buttons, drop down lists, hyperlinks, and the like. Once prepared, the user can preview the custom generated report as well as save it or export it to multiple formats. For example, the custom generated report can include text, tables, graphics, and the like. The web-based report design interface access data in databases, such as a relational database, through virtual or physical network connections.

The web-based report design interface enables the user to select multiple data sources. From each data source, the user can select one or more fields from which the user can filter, reduce, and/or select the data. Additionally, the web-based report design interface supports custom filtering and functions applied to the fields for the purposes of generating a custom report. Advantageously, the ad-hoc reporting system enables the custom report generation solely from a web browser or the like. This enables the generation of data access language queries or driving a user interface without requiring the creation of additional configuration items like catalogs, models or secondary schemas by a programmer, operator, or database administrator. Thus, business users are afforded a level of freedom and autonomy, and IT staff may be freed to focus on other initiatives.

### Ad-Hoc Reporting System

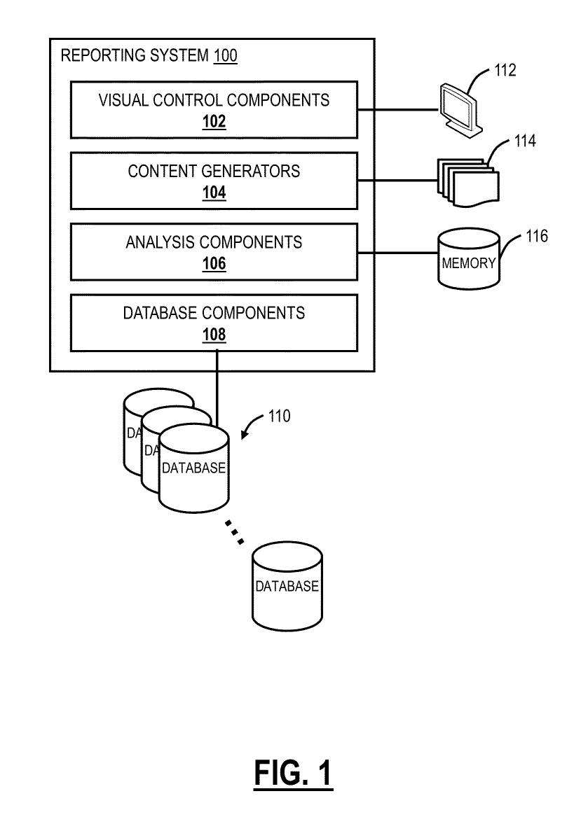

Referring to FIG. 1, in an exemplary embodiment, a network diagram illustrates a reporting system 100 which includes visual control components 102, content generators 104, analysis components 106, and database components 108. The reporting system 100 includes software which includes an ordered listing of executable instructions for implementing logical functions associated with the reporting system 100. For example, the reporting system 100 can be configured to run on a computer, such as a server, connected to databases 110. The various components 102, 104, 106, 108 are configured to function or execute on the server, a local client, or both. The components 102, 104, 106, 108 can also include counterparts on the server and the client which communicate to each other through events. Additionally, the components 102, 104, 106, 108 can also communicate with other such components 102, 104, 106, 108 through events, delegates, direct method calls, indirect method calls, data exchange, or the like. Note, the components 102, 104, 106, 108 are shown separately for logical purposes, and they may be integrated, functionally split, etc.

The visual control components 102 are software components configured to render directly or indirectly to an interactive UI 112, such as a web browser, mobile app, etc. The interactive UI 112 may be the web-based UI described above providing a user reporting access to the databases 110. The visual control components 102 can include, for example, a field list selector, a filter list selector, a summary field list selector, a chart selector, a data source selector, and the like. These selectors are configured to allow a user to interactively and simply create a customized report through the UI 112 without special software or database programming knowledge. Also, the visual components 102 can automatically pre-select the most likely intended fields, operations, or combinations thereof in a manner that may be overridden by the user. Each combination of fields, operations or combinations thereof can be given points for certain attributes and the combination with the highest score gets automatically selected, i.e. scorecarding. Scorecarding figures out how various fields, operations or combinations thereof are related based on connections in a data source or previous history, and scores results selecting the highest scored results. For example, in the chart selector, scorecarding can auto-select a field such as a date field when a user selects a trend chart. Further, the scorecarding can select a group by month operation for the dates if a user previously has run reports based on grouped months. In another example, scorecarding can be utilized when data sources are joined based on the most likely combination of fields. In an exemplary aspect, the visual control components 102 only display valid functions, selections, etc. to the user, thus preventing invalid SQL queries or the like to the databases 110. Also, the visual control components 102 can be configured to automatically display, update, etc. interactive visualizations based on selections made by a user in the databases 110.

The content generators 104 are software components configured to render visual translations, transformations, or visualizations of data to form content 114, such as, for example, charts, grids, tables, interactive visualizations, and the like. The reporting system 100 can include multiple content generators 104 for various formats, such as PDF, XLS, DOC, XML, SQL, JPG, GIF, PNG, and the like, and multiple content generators for various types of content, such as table, charts, grids, and the like. The content generators 104 can encapsulate, utilize, or call upon other content generators 104. For example, a PDF document with a chart in it could be rendered by a PDF content generator component that embeds the output of chart content generator which can be further compressed by a graphical file format content generator that generates a graphical format such as GIF, JPG, PNG, or other graphical file format.

The analysis components 106 are configured to analyze, evaluate, connect, translate, transform, or represent relational metadata and data from the databases 110. The analysis components 106 provide a link between the content generation 104 and the database components 108. For example, the analysis components 106 are configured to generally construct the representations in memory 116 for efficient access, modification, transfer, storage, and retrieval. The analysis components 106 are configured to perform real-time analysis on the metadata. The metadata analysis components include various drivers, and a metadata cache. The various drivers act as communication protocols between the components and generators of the reporting system 100 and the database 110. The drivers utilize techniques specific to each database 110 to each database type, such as Oracle, Microsoft SQL Server, MySQL, DB2, Sybase, Hadoop, MongoDB, and the like, to gather information about what tables, views, fields, and the like are in the database 110.

The database components 108 connect to, transfer data from, and communicate with the databases 110 or other database components. A driver and provider or other abstraction layer can abstract database operations such that the reporting system 100 can easily connect to multiple types of database servers or data applications as an intermediary layer so that the entire system need not change to support an additional vendor, database type, data source, or data application. Advantageously, this allows the reporting system 100 to operate with any type of database 110 to generate custom reports without any knowledge of the specific database type or of SQL. The other components 102, 104, 106 in the reporting system 100 utilize the database components 108 to gather data, metadata, or other relevant data from the source database 110. The visual control components 102 are configured to adapt based on the specific type of database that the database components 108 connect to. Specifically, the UI 112 is configured to only allow characteristics and capabilities associated with the specific database type. Additionally, the analysis components 106 are also configured to operate according to the characteristics and capabilities associated with the specific database type.

For example, different database types can include Oracle, Microsoft SQL Server, MySQL, DB2, Sybase, Hadoop, MongoDB, and the like. Each type of database can include similar field types, such as string, integer, varchar, date, float, etc. However, each database type may allow different operations, i.e. sorting, aggregating, grouping, and filtering, for each field type. The reporting system 100 is aware of the nuances associated with each field type for each different database type. For example, one database type may allow numerical operations with string fields while another may not. The awareness of the specific field type for the specific database type enables the reporting system 100 to provide the same UI 112 for report generation to a user regardless of database type. Advantageously, this enables the user to generate custom reports without intimate database knowledge.

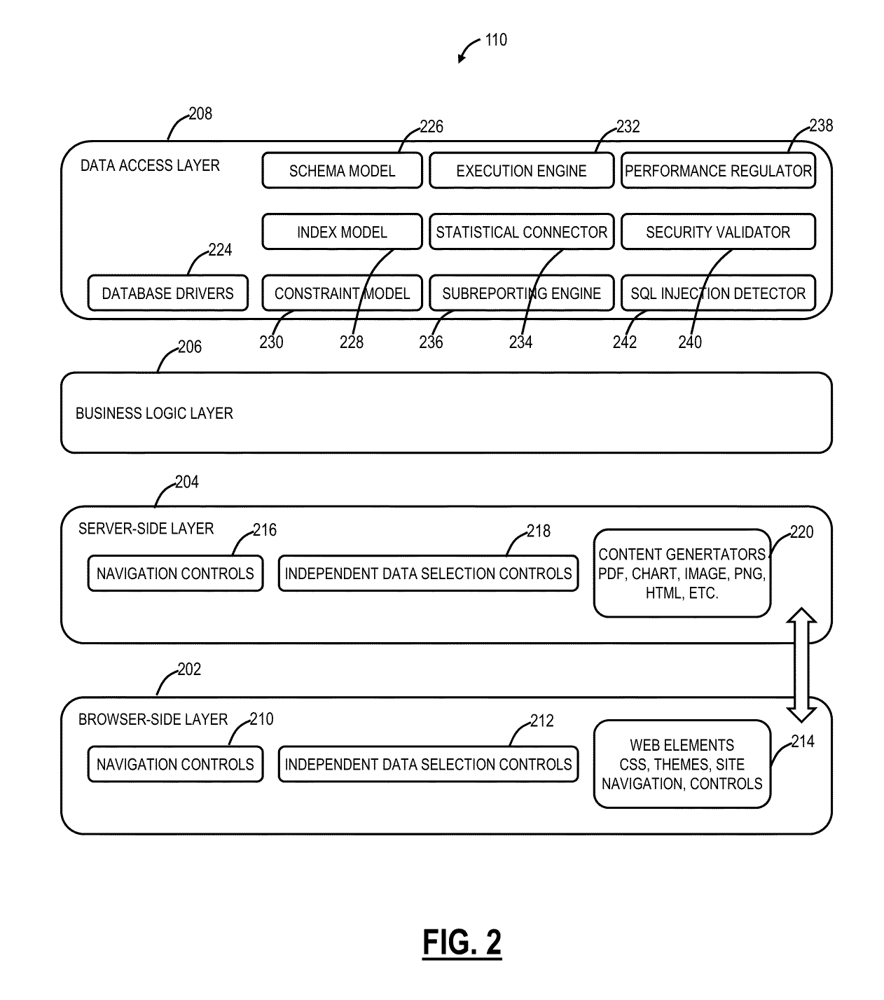

Referring to FIG. 2, in an exemplary embodiment, a block diagram illustrates a further detailed representation of the reporting system 100 illustrating general sub-components and modules. In FIG. 2, the reporting system 100 is logically shown in functional layers including a browser-side layer 202, a server-side layer 204, a business logic layer 206, and a data access layer 200, i.e., the representation in FIG. 2 illustrates a way to encapsulate data, business logic, and server and client presentation components of the reporting system 100. As described herein, the reporting system 100 can operate external to a database avoiding custom integration. Additionally, users can access the reporting system 100 through a standard web browser configured with scripting capabilities or the like. The various layers 202, 204, 206, 208 are part of a reporting system 100 which can operate on a server. The layers 202, 204, 206, 208 are configured to provide the functionality between users with web browsing devices and databases for generation of custom reports.

Each component in both the browser-side layer 202 and the server-side layer 204 works together with a counterpart. For example, the browser-side layer 202 includes navigation controls 210, independent data selection controls 212, and web elements 214. The server-side layer 204 includes navigation controls 216, independent data selection controls 218, and content generators 220. The navigation controls 210, 216 are configured to control navigation through the reporting system 100 on both the user side (i.e., browser, mobile app, etc.) and server side (i.e., the reporting system 100). For example, the navigation controls 210, 216 can include the various tabs illustrated in the UI screens. These controls 210, 216 maintain the current state of the reporting system 100 based on user navigation through the tabs where the state corresponds to the various fields, lists, etc. presented to the user.

The independent data selection controls 212, 218 provide a mechanism for selection of data, fields, etc. based on selections by the user and auto-selection by the reporting system 100. For example, the user can select a data source or the like through a pull down menu, etc. Correspondingly, the reporting system 100 can automatically select fields based on scorecarding. The web elements 214 are configured to utilize buttons, controls, etc. in a UI for the user. The content generators 220 are configured to provide HTML for the web browser and report output in various binary file formats, or any other format.

The business logic layer 206 is configured to coordinate all behaviors between the server-side layer 204, the browser-side layer 202, and the data access layer 208. For example, when a user clicks another tab through the navigation controls 210, 216, the business logic layer 206 coordinates the underlying functions. Additionally, the business logic layer 206 includes control functions based on rules associated with the reporting system 100. For example, upon creation of a new report, a user cannot preview the report if only data sources are selected, but no fields are selected. Here, the business logic layer 206 acts as a mediator for applying things—e.g. drop-down, a database may not allow an average of string fields.

The data access layer 208 includes various functions associated with accessing data in a database. Database drivers 224 are configured to interact with various database types. The drivers 224 are configured with an intimate understanding of a specific vendor's database including various limitations, capabilities, nuances, and the like associated with the database. The reporting system 100 is configured to operate “off-the-shelf” with numerous database types. Advantageously, this allows custom report generation without custom development since the reporting system 100 is already configured to interact with the database. For example, the various supporting database vendors can include Oracle, Microsoft SQL Server, MySQL, DB2, Sybase, Hadoop, MongoDB, and the like.

Models 226, 228, 230 represent in-memory representations of a database state. A schema model 226 defines tables, fields in each table, and relationships for data sources from the database. The reporting system 100 is configured to dynamically and automatically generate the schema model 226 to provide custom reports. Also, the schema model 226 does not even need to be stored, but rather it can be generated on the fly as the report is generated. An index model 228 is similar to the schema model 226, but focuses on indexes associated with the database. A constraint model 230 focuses on constraints associated with the database. For example, the constraint model 230 prevents building relationships, such as relationships prevented by the database itself or by a DBA. The index model 230 provides additional performance and reliability aspects associated with the reporting system 100.

An execution engine 232 provides back and forth handling of queries and movement of data. A statistical connector 234 is configured to perform probabilistic analysis associated with the reporting system 100. For example, the probabilistic analysis can include the scorecarding algorithm and color highlighting of data (e.g., data in the 90^{th} percentile is highlighted). A subreporting engine 236 is configured to enable look up and embedding of other reports. For example, this can include a pop-up subreport, and the subreporting engine 236 is configured to handle functions associated with this subreport. A performance regulator 238 is configured to provide performance regulation. For example, a drop down list may include millions of values, and displaying all values may cause the reporting system 100 to crash or take a significant amount of time. The performance regulator 238 is configured to prevent this by providing a fixed number of records or to stop after a predetermined time. A security validator 240 prevents users from adding fields that they do not have access to. Also, the validator 240 prevents hackers from building reports, hides reports/information, etc. The security validator 240 can also change based on a background change to a security model. A SQL injection detector 242 looks for and prevents malicious activity based on SQL statements, e.g. hackers injecting special marks.

### Ad-Hoc Reporting Over the Internet

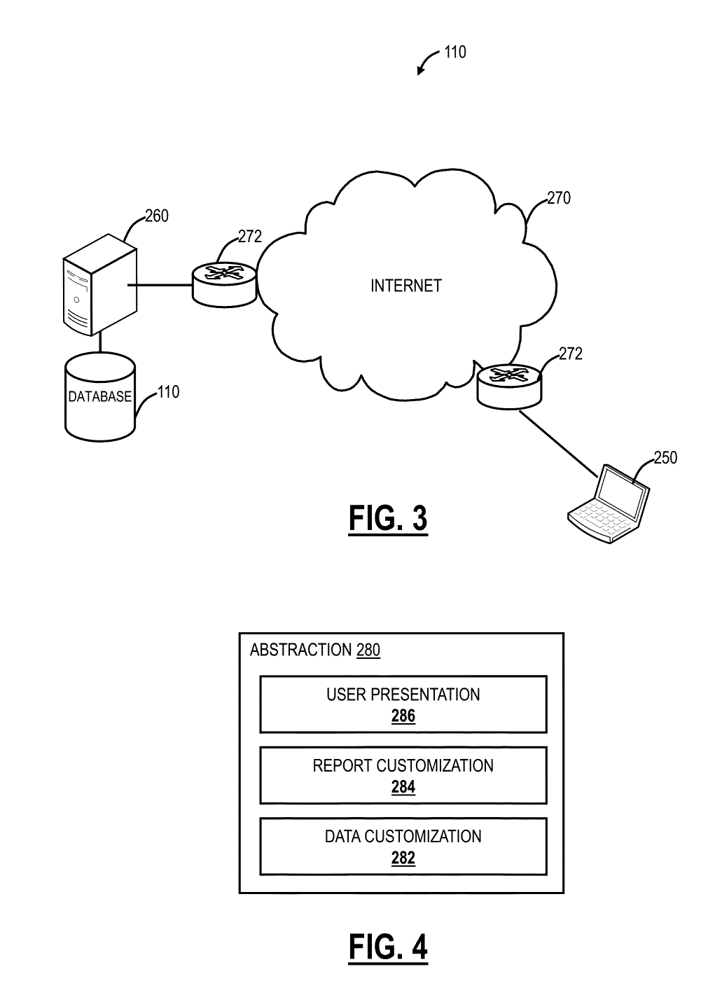

Referring to FIG. 3, in an exemplary embodiment, a network diagram illustrates an operation of the ad-hoc reporting system 100. Here, a client 250 is connected to a server 260 through the Internet 270, routers 272, etc. Collectively, the server 260 and the client 250 are implementing the reporting system 100. The client 250 can include a laptop, a desktop, a tablet, a netbook, an ultra-book, a smart phone, or any other processing device that is communicatively coupled to the server 260 via the Internet 270. The client 250 can implement a Web browser, mobile app, etc. for accessing the server 260. The Web browser can include Internet Explorer (available from Microsoft Corp.), Netscape (available from Netscape Communications), Firefox (available from Mozilla), Opera (available from Opera Software), Safari (available from Apple, Inc.), and the like, and the client device 250 can have an operating system such as Windows, Linux, Mac OS, Chrome, iOS, Android, and the like. Also, the web browser does not require any special configuration or plug-in software, and the client 250 can access the reporting system 100 through the web browser without any other software required on the client 250. Additionally, a firewall (not shown) may be included protecting access to the Internet 270. The server 260 is configured to operate through a firewall.

The server 260 is configured to communicate with one or more databases 110. For example, the databases 110 can include, without limitation, Oracle, Microsoft SQL Server, MySQL, DB2, Sybase, Hadoop, MongoDB, and the like. In one exemplary embodiment, the database 110 can physically be collocated with the server 260, and even part of the same computer system. In another exemplary embodiment, the database 110 can be remotely connected to the server 260 such as over the Internet 270 or through a VPN. The server 260 is configured to utilize existing mechanisms to connect to the database 110. These mechanisms can include special protocols for each different database type. A user can utilize the client 250 to securely log into the server 260 over the Internet 270 and design custom reports through the reporting system 100. For example, the user can have security credentials to log into the server 260. For the database 110, the user can have a connection string or password which provides both an address and security credentials for the database 110. Once the credentials are supplied, the reporting system 100 is configured to automatically provide data sources to the user and the associated UI screens for creating a custom report or interactive visualizations based on the type of the database 110.

Interactions between the client 250 and server 260 can include client side scripting which eliminates most page refreshes. Here, the client 250 includes a web browser which supports client side scripting capabilities, such as AJAX. The client 250 and the server 260 can communicate utilizing the hypertext transfer protocol (HTTP) or HTTPS. Accordingly, the reporting system 100 utilizes a scripted browser environment, and not a desktop client. This allows rapid deployment of the system 100 since no clients are installed on a user's computer. Advantageously, the use of HTTP allows any browser with scripting to be configured to connect to the server 260 without special security configurations.

### Ad-Hoc Reporting Abstraction

Referring to FIG. 4, in an exemplary embodiment, a block diagram illustrates various levels of abstraction 280 associated with the reporting system 100. In a first level, the reporting system 100 performs data customization 282 which includes various filters and criteria associated with data customization. Here, data is customized based on various operations. Next, the reporting system 100 includes a report customization level 284. Here, the reporting system 100 allows actual customization of the report itself. For example, different fields, groupings, sortings, and the like can be implemented. Advantageously, the reporting system 100 performs this over HTTP/HTTPS and requires no knowledge of SQL or of characteristics and capabilities of the specific database type. Instead, the reporting system 100 itself is aware of the characteristics and capabilities and presents a user an easy-to-use UI in lieu of SQL commands. This enables end users to perform report customization without intimate database knowledge. In a third level of abstraction, a user presentation level 286 provides an adaptable UI for report customization based on the specific type of database used. Here, the UI enables valid custom reports by only showing users report options within capabilities of the specific database type. Further, the UI provides warnings or automatic corrections based on invalid combinations.

### Exemplary Server Architecture

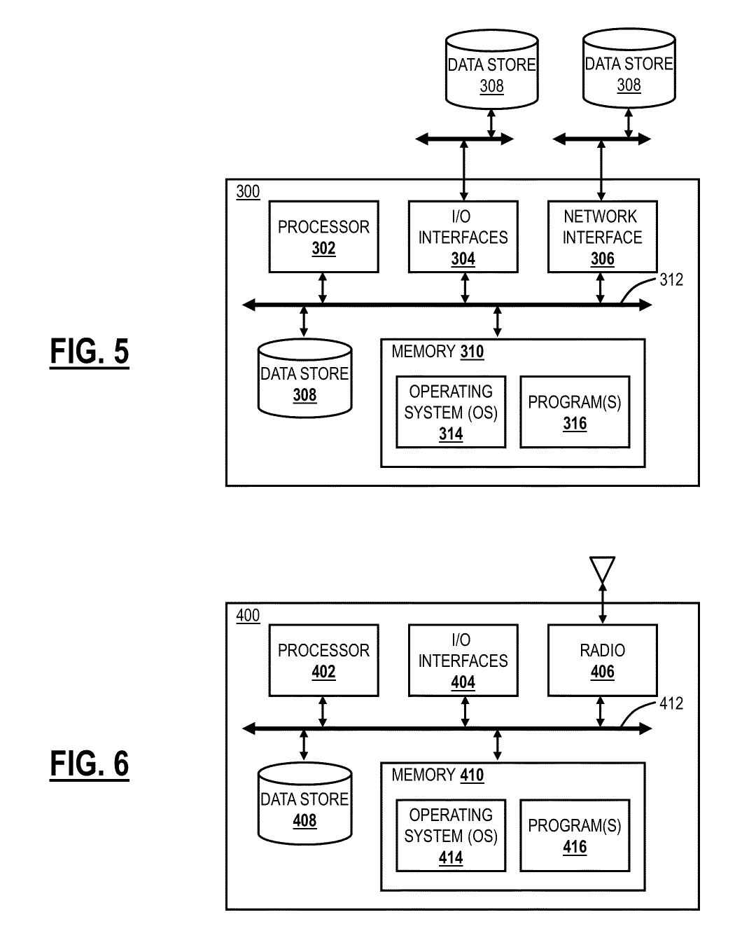

Referring to FIG. 5, in an exemplary embodiment, a block diagram illustrates a server 300 which may be used in the reporting system 100, in other systems, or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 5 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the WAN 101, the enterprise 200, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 includes a suitable operating system (O/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein.

### Exemplary Mobile Device Architecture

Referring to FIG. 6, in an exemplary embodiment, a block diagram illustrates a mobile device 400, which may be used in the reporting system 100 or the like. The mobile device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 6 depicts the mobile device 410 in an oversimplified manner, and a practical embodiment may include additional components and suitably configured processing logic to support known or conventional operating features that are not described in detail herein. The components (402, 404, 406, 408, and 402) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the mobile device 410, a semiconductor-based microprocessor (in the form of a microchip or chip set), or generally any device for executing software instructions. When the mobile device 410 is in operation, the processor 402 is configured to execute software stored within the memory 410, to communicate data to and from the memory 410, and to generally control operations of the mobile device 410 pursuant to the software instructions. In an exemplary embodiment, the processor 402 may include a mobile optimized processor such as optimized for power consumption and mobile applications. The I/O interfaces 404 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the mobile device 410. Additionally, the I/O interfaces 404 may further include an imaging device, i.e. camera, video camera, etc.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 6, the software in the memory 410 includes a suitable operating system (O/S) 414 and programs 416. The operating system 414 essentially controls the execution of other computer programs, and provides scheduling, input-output control, file and data management, memory management, and communication control and related services. The programs 416 may include various applications, add-ons, etc. configured to provide end user functionality with the mobile device 400. For example, exemplary programs 416 may include, but not limited to, a web browser, social networking applications, streaming media applications, games, mapping and location applications, electronic mail applications, financial applications, and the like.

### Automatic, Interactive Visualizations in an Ad-Hoc Reporting System

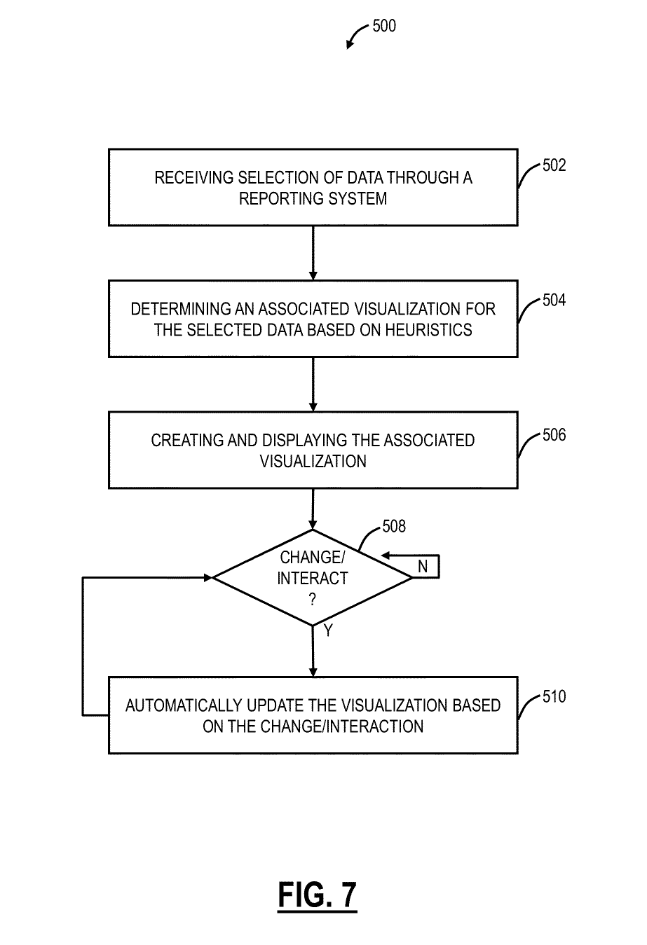

Referring to FIG. 7, in an exemplary embodiment, a flow chart illustrates a visualization method 500 that can be implemented through the reporting system 100. The visualization method 500 includes receiving selection of data through the reporting system 100 (step 502), determining an associated visualization for the selected data based on heuristics (step 504), and creating and displaying the associated visualization (step 506). Optionally, the visualization method 500 can include changing the selected data and/or interacting with the visualization (step 508), and automatically updating the visualization based on the change or interaction (step 510). The visualization method 500 can be characterized as a “one-click” or even “no-click” visualization process in that decisions about how to present the visualization, type of visualization, etc. are automatically determined without user input.

Data collection has proliferated, and it expected to continue. However, the skill and expertise of a typical user has not grown at the same level. Thus, there is a fundamental disconnect between the available data and how to visualize this data. It is not realistic to expect users to become IT experts. In this manner, the visualization method 500 seeks to provide automation on the back end to provide an extensible modern, HTML-based visualization framework for big data visualization. The visualizations can be used in a single report or combined with other elements into a dashboard. Visualizations can be in the report designer, at the script level or via a WYSIWYG-like designer. The visualizations are designed in HTML technologies like JavaScript, HTML, Web Graphics Library (WebGL), Cascading Style Sheets (CSS), Scalable Vector Graphics (SVG) and CSS3D, and libraries like jQuery and Data-Driven Documents (D3).

The visualization method 500 is described from the perspective of a device, such as the server 260, but those of ordinary skill in the art will recognize the visualization method 500 can be implemented across various devices through the reporting system 100. For example, each visualization can take input JSON data from a response server and use it to render an animated visual output. Users can even extend the visualization method 500 by creating their own visualizations or adding open source and third party visualizations. Visualizations can be used in a single report or combined with other types of visualizations, reports and forms into a dashboard. Again, the visualizations can be in the report designer, at the script level, or via a WYSIWYG-like designer.

The visualization method 500 is a low lightweight low-ceremony approach to creating data visualization user experiences. It abstracts the details of the data storage layer so that visualizations and user experiences can work with any data source without having to understand the nuances of each one. For example a heat map visualization could work on relational data, a document database or a Representational state transfer (REST) Application Programming Interface (API). The back end interface would be responsible for performant data aggregation.

The visualization method 500 can be a D3-based visual supplement to a core charting engine. Visualizations can be rendered in a chart report part, but are built on the columnar data in summary or fields views. These columns must be arranged in a specific order to provide valid data for certain visualizations. This visualization method 500 can include adjusting column arrangement to work with each visualization style, or more particularly to the selected visualization.

A field and a column can be the same thing. The foregoing descriptions refer to fields and columns interchangeably. To be precise, fields are listed from top to bottom on a Fields view, and displayed as columns from left to right. When creating a visualization, the visualization method 500 must pay specific attention to the field order. This is the idea that fields, from top to bottom, can be numbered—the first field in the list is 1, the second field is 2, and so on. Likewise, the leftmost column is column 1, the column immediately to the right is column 2, and so on. This field order is critical, as visualizations demand a specific order to fields which dictates not only if they will be used, but how they will be used.

Some visualizations permit multiple group fields. Group field hierarchy must be placed in proper field order with the visualization method 500. This means highest category first, and lowest category last. Here are some examples:

Country, State/Region, City, Neighborhood

Company, Department, Office, Desk

Tera, Giga, Mega, Kilo

Year, Month, Day, Hour

Expressions read the exact field order as it is defined. If a user places Neighborhood before Country, the resulting visualization will not make any sense by definition. In this manner, the visualization method 500 can either auto-correct or display an error message. The visualization method 500 can include a hierarchy check on the selected data. That is, the visualization method 500 can enforce a proper hierarchy of fields, i.e. time-based, geographically-based, etc., and rearrange accordingly, e.g., the visualization method 500 can change it so that a city is not before a country, a month is not before a year, etc.

Some visualizations support dynamic filtering and drilldown-like behavior. A visualization can exist on a child report, and can exist on a parent report. The drilldown terminology in this case means that some visualizations, like heatmap and sunburst, can drilldown within themselves. This is more accurately described as dynamic filtering. Dynamic filtering the visualization will also filter the linked summary or detail view.

Some visualizations can accept an indefinite number of fields as metrics. These fields are noted with a + after the field number order, in the foregoing descriptions. That is to say, if a visualization requires 3 and only 3 fields, its fields will be listed as 1, 2, 3. However, if a visualization can have multiple fields after the first two fields which define its boundaries, its fields would be listed as 1, 2, 3+. In other words, after the mandatory fields 1 and 2, one could have fields 3, 4, 5, 6 which all serve as additional selectable metrics. Generally only one of these fields will be displayed at a time, but with the option of selecting between them. Some visualizations can accept a large number of fields as groups. These fields are noted with a “ . . . ” after the field order number. This means that if a visualization accepts multiple levels of hierarchical data, one could have 5 group fields representing hierarchy in fields 1 through 5, and begin metrics at field 6. In the foregoing descriptions, this will be noted as Field 1 . . . , Field 2. This does not mean that the metric needs to be in the actual second field. This means that the metric field(s) must be placed after all of the group fields in fields 1 through X. Some visualizations do not care where a field is, so long as it exists. These fields are noted with a “?” after the field order number. This means that it is not necessary to place that field in the noted order.

The foregoing terms refer to the types of columns that each visualization reads.

Group—This column can be any data type, aggregated or not aggregated. These columns are used to group data in other columns, and often serve as the axis or scale of a particular visualization.

Time—This column must be a Datetime data type.

Metric—This column can be any data type. It is generally an aggregate, and most commonly a numeric, but does not have to be. These columns are the elements that are being charted, mapped, or displayed on a visualization.

Geographic Field—This column is a special case. It is used in map-style visualizations. It must be a list of geographic entities, such as a list of countries, regions, or states.

There can be filtered interaction between multiple visualizations. If the same fields are used in several visualizations on the same report or dashboard, then interacting with one of them will not only affect the associated grid, but any visualization on the screen that shares data sources with similar or the same fields. For example, imagine clicking the state or Georgia on the map, the pie chart under the map can show election totals by party—which would change as one hovers over different states.

### Visualization Types

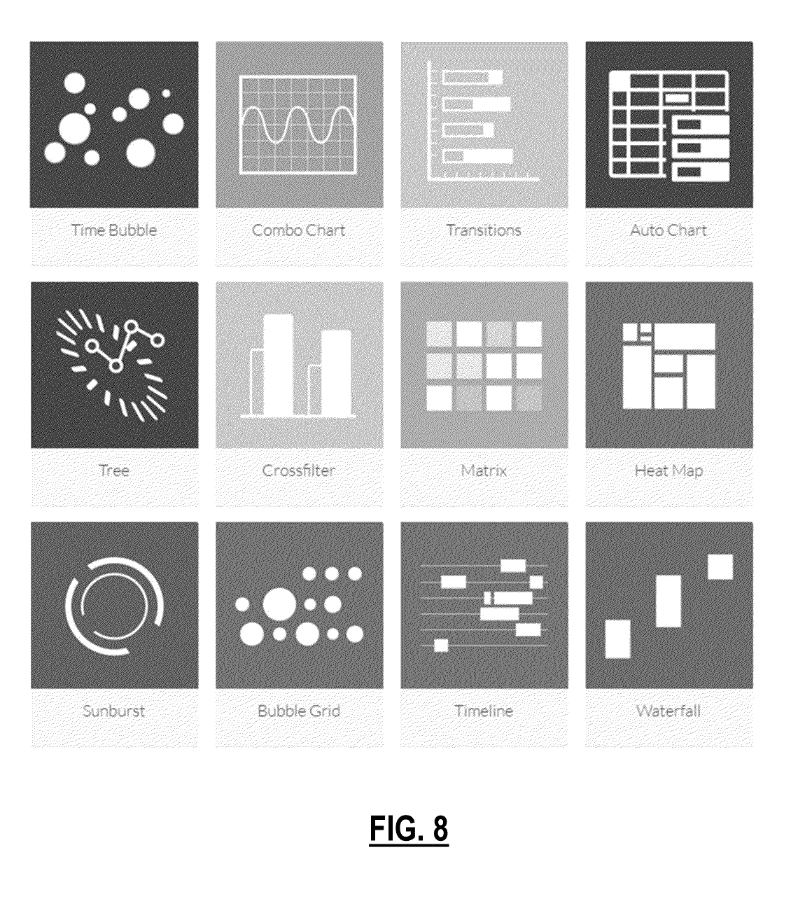

Referring to FIG. 8, in an exemplary embodiment, a diagram illustrates various exemplary types of visualizations contemplated with the visualization method 500. Note, the visualization method 500 contemplates other types of visualizations as well. The exemplary types of visualizations can include, without limitation, a time bubble, combo chart, transitions, auto chart, tree, crossfilter, matrix, heat map, sunburst, bubble grid, timeline, waterfall, geographic map, etc. Again, one unique aspect of the visualization method 500 is that it decides the best type of visualization based on the selected data. In the foregoing discussions of the types of visualizations, examples of the heuristics are also discussed, i.e., how does the visualization method 500 know to select which type of visualization.

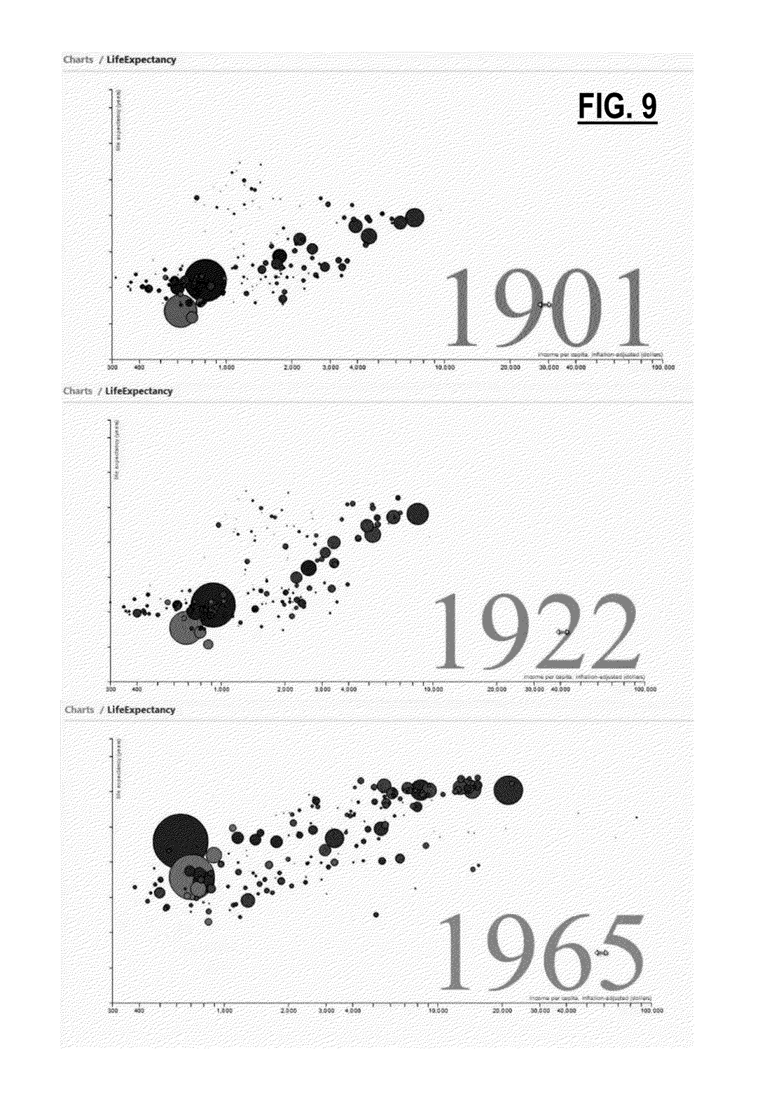

A Time Bubble is a multidimensional graph which displays circles which change in size and position over time. Hovering over the time label on the chart will move forward and backward in time. For example, FIG. 9 illustrates an exemplary time bubble for life expectancy and per capita income of major nations over time. While not show in the static graphics of FIG. 9, one can move over time via hovering (mouse or pointer movement, gestures, etc.). Aspects of the time bubble include
Field 1—Group—This field will represent each circle.
Field 2—Datetime—This field will determine the scale at which circles move and change size. This field must be set to Group (Year & Month).
Field 3—Metric—This field will represent the Y axis.
Field 4—Metric—This field will represent the X axis.
Field 5—Metric—This field will represent the Z axis, represented by the area of the circle.
   Note, the time bubble can be a 2D graph, as shown in FIG. 9, or a 3D graph. For the heuristics, the time bubble is advantageously selected to show how data evolves over time.

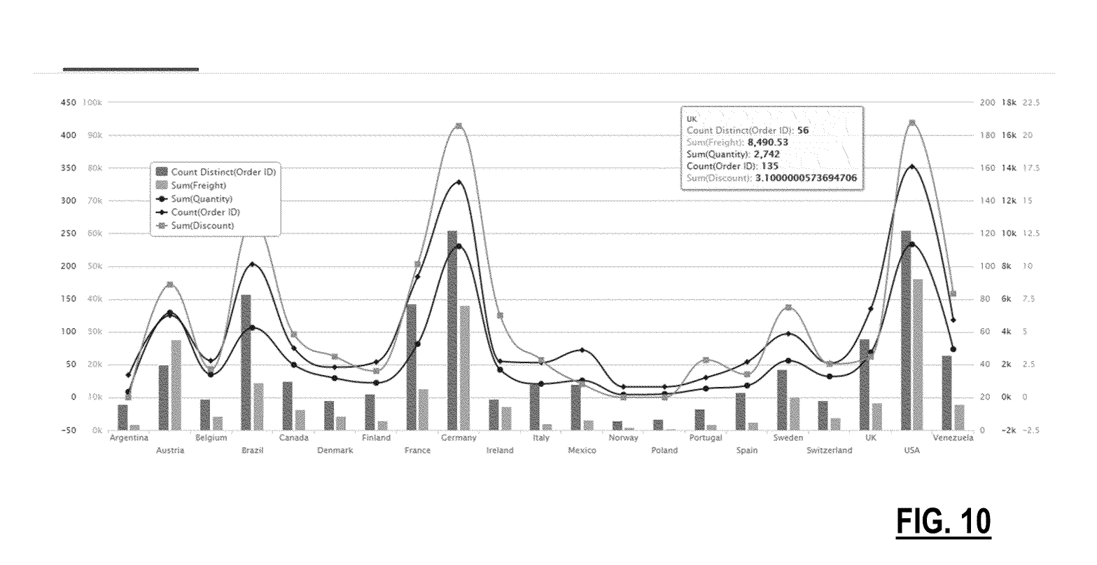

A combo chart displays metrics with a series of bars and lines on the same graph. Each metric gets its own Y axis, with the X axis determined by the single group field. The first half of the metric fields will be displayed with bars, the second half with lines. FIG. 10 illustrates an exemplary combo chart. Aspect of the combo chart include
Field 1—Group—This field will represent the categories along the X axis.
Field 2+—Metric—This field will represent the values of each bar or line. Each bar or line will receive its own scale on the Y axis.
   The Metric fields will be split between bar and line graphs. The first half of the metric fields can be bars, and the second half can be lines. For the heuristics, the combo chart is useful to display multiple comparison of discrete fields.

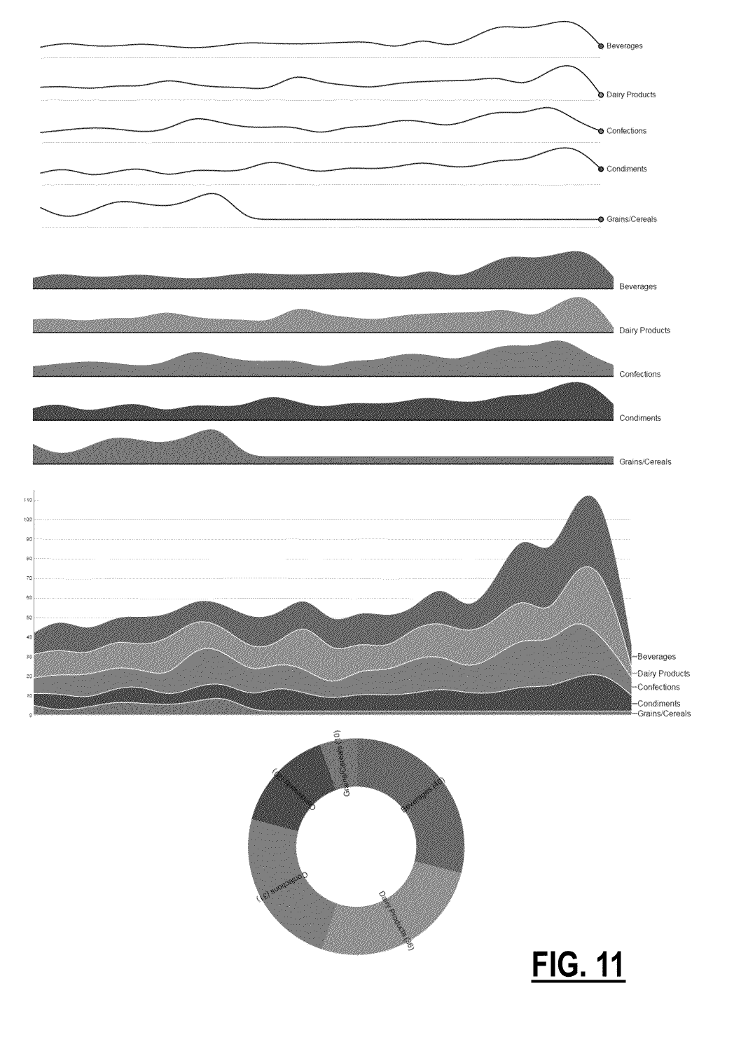

A transitions visualization displays multiple graphs styles in a sequence with a same data set. For example, FIG. 11 illustrates a same data set—product order quantity over time for different product types. Note, the different graphs all show the same data, presented in a different form. Aspects of the transitions visualization include
Field 1—Group—This field represents categories on the Y axis or slices of proportional charts.
Field 2—Datetime—This field represents the X axis when applicable. It must be set to Group (Year & Month)
Field 3—Metric—This field represents the value.

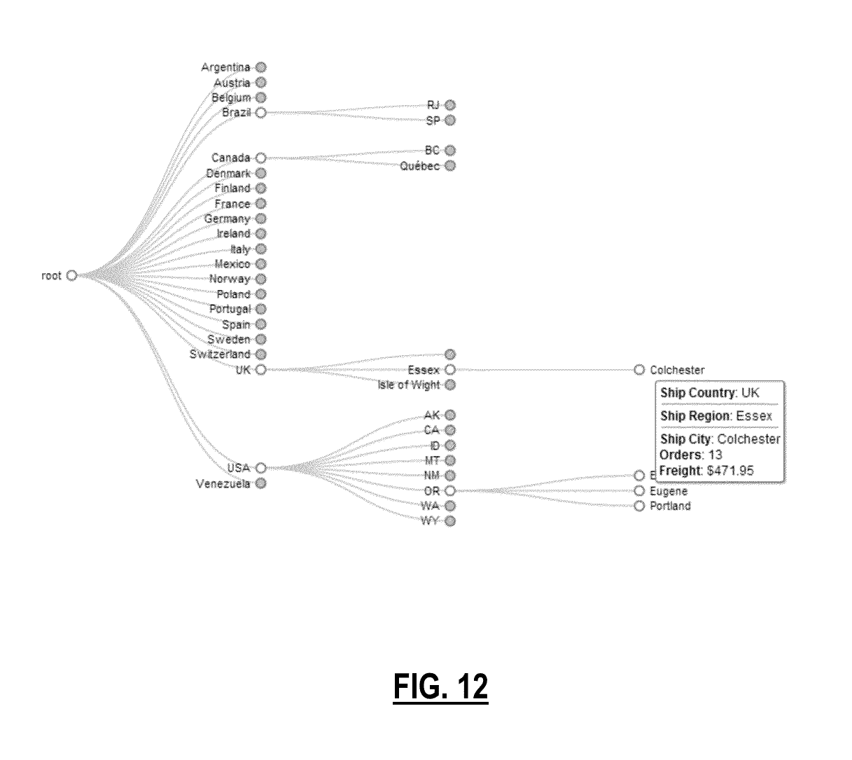

A tree visualization allows a hierarchy to display, expand, and contract. For example, ehen one gets to the lowest point in the hierarchy, one can hover over the terminal point to display aggregate values. FIG. 12 is an exemplary tree.

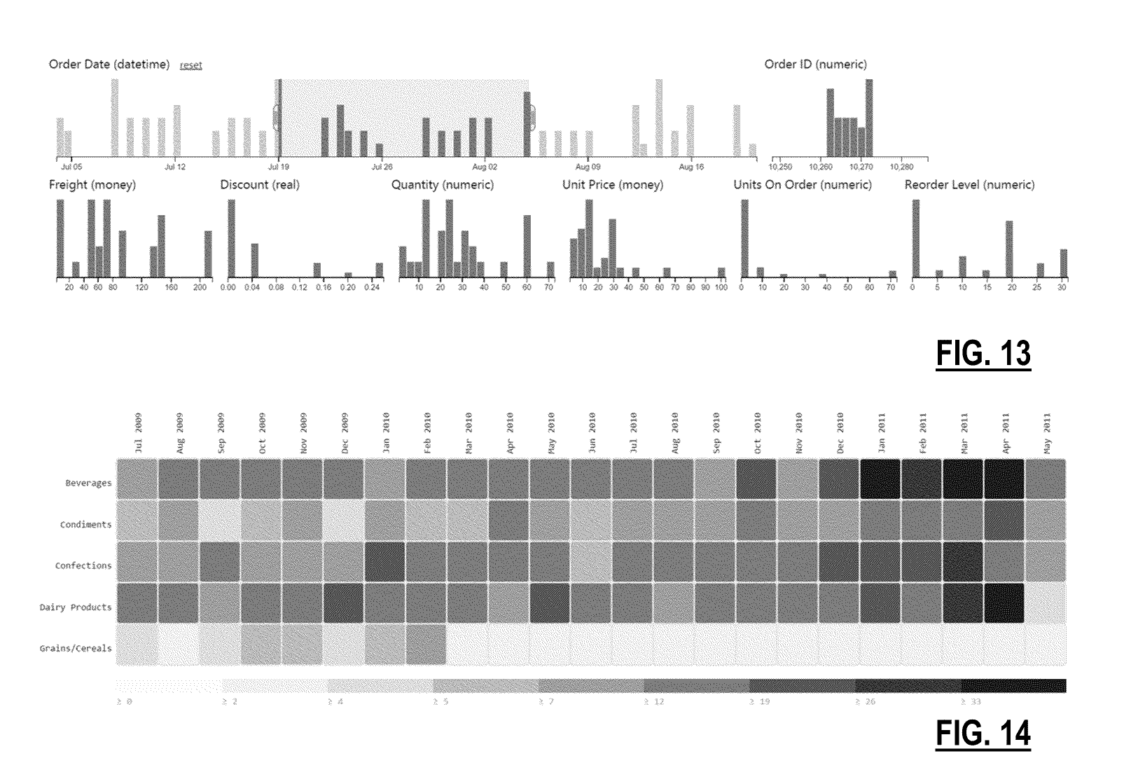

A crossfilter visualization displays multiple charts, one for the datetime grouping field and one for each metric. Clicking and dragging on any chart will establish a range, which acts as a filter on all other charts. One can also drag the range itself to move it without changing its size. This chart is useful for finding clusters of data within other data, for example, having less orders in June vs. August, but they are worth more money. FIG. 13 is an exemplary crossfilter visualization, and the crossfilter visualization has the following
Field 1?—Datetime—This field will represent the time factor by which other metrics can be filtered. Range of values is displayed on the X axis and count of values is displayed on the Y axis.
Field 2+—Metric—This field will represent the value. Range of values is displayed on the X axis and count of values is displayed on the Y axis.

A matrix visualization displays a series of squares, arranged by group and time, in the style of a pivot. The squares are shaded according to each metric value. FIG. 14 is an exemplary matrix visulation, and the matrix visualization has the following
Field 1—Group—This field will represent the categories along the Y axis.
Field 2—Time—This field will represent the categories along the X axis. This field must have the function set to Group (Year & Month).
Field 3—Metric—This field will represent the value of each square.

A heatmap visualization displays a tree-like hierarchy of squares, each of which proportionally represents the aggregate metric at each level of the hierarchy. The heatmap visualization allows one to see the relative amount of an aggregate value in comparison to other values along a hierarchical axis. For example, it can use Country, State, and City as axes for a given aggregate value. The treemap can be drilled down on to provide more detail, for example clicking on a given country will zoom the map to that country and all states and cities which are contained within. One can only visualize one aggregate value at a time, but one can switch between multiple values using a side dropdown menu. Values which are not currently being displayed will appear in the tooltip shown when hovering over a visual block. The heatmap visualization has the following
Field 1 . . . —Group—This field represents the hierarchical levels which structure the heat map.
Field 2+—Metric—This field will represent the value on the chart. The metric currently being displayed is selectable from a dropdown.

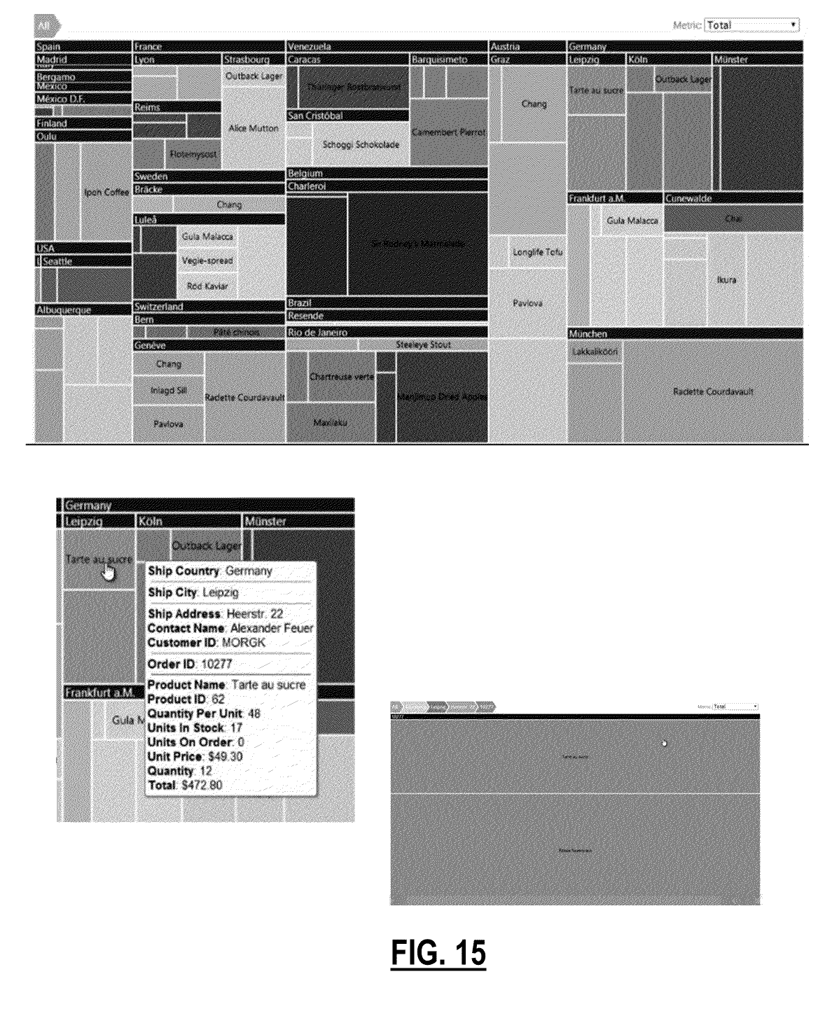

FIG. 15 is a diagram of a heatmap at various drilldown points. The heatmap uses size, color, and position to represent large quantities of data visually that is easy to identify and explore. For example, total sales volume could be size and colors could be product category. Hovering over a specific product can show details and it can be clicked on it to dive into that area, as shown in FIG. 15. The heatmap, like other visualizations, can include a breadcrumb trail which enables navigation backwards. The heatmap can include zooming where a first level is based on the left most fields and, as one zooms, it goes left-to-right to create automatic drill-downs.

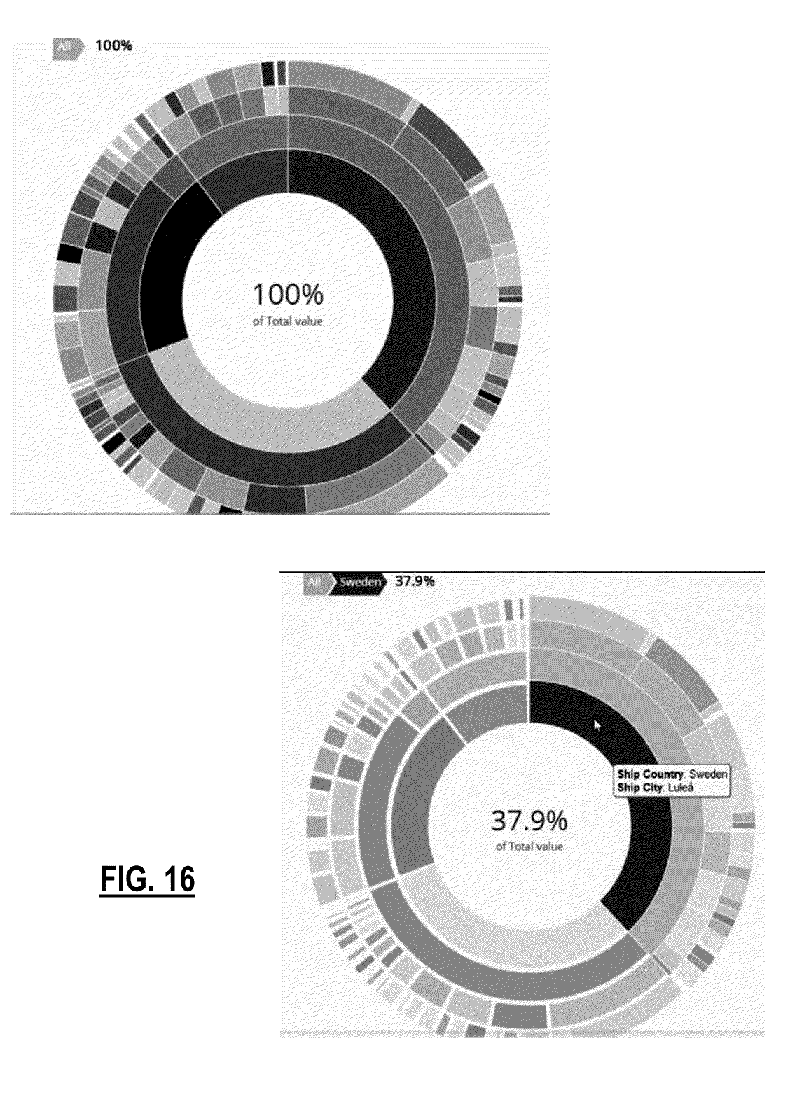

A subburst visualization displays a tree-like hierarchy of items layered in a circular arrangement, each of which proportionally represents the aggregate metric at each level of the hierarchy. The layers from inner to outer represent each level of the hierarchy. Larger groups are displayed from the 12 o'clock position clockwise. FIG. 16 illustrates a subburst visualization, at 100% and a drill-down to 37.9%. Also, note the subburst visualization includes a breadcrumb trail at top—go back—to previous level or the beginning. The Sunburst visualization is a reinvention of the pie chart; an inside ring is a traditional pie chart, hover over slices to show information about countries, outer rings are a visual hierarchy of all the data present—click on one and entire visualization transforms to that particular part of the hierarchy. The subburst visualization includes
Field 1 . . . —Group—This field represents the hierarchical levels which structure the heat map.
Field 2+—Metric—This field will represent the value on the chart. The metric currently being displayed is selectable from a dropdown.

Based on the data size, certain visualizations like sunburst, heamap, etc. may be selected because they scale to larger data volumes. Interactivity may also be automatically imposed for large data sets. For example if data ranges from 1 to 1000. Ranges may be used for top level like “1-100”, “101-200”. This can be viewed as like pagination but inside an interactive visualization, such as a pie chart or the like.

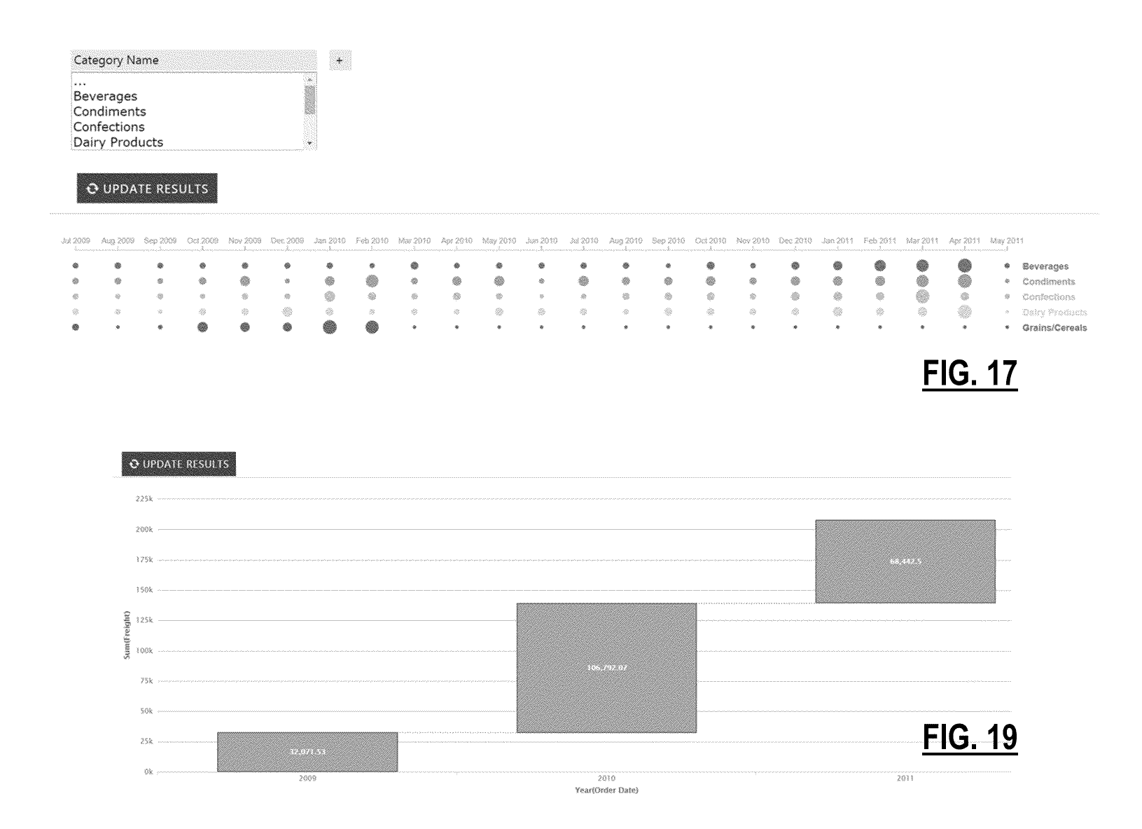

A bubble grid displays a circle with the area representing the metric field by the group field and the time field. FIG. 17 illustrates an exemplary bubble grid, and the bubble grid has
Field 1—Group—This field will represent the categories along the Y axis.
Field 2—Time—This field will represent the categories along the X axis. This field must have the function set to Group (Year & Month).
Field 3—Metric—This field will represent the value of each bubble.

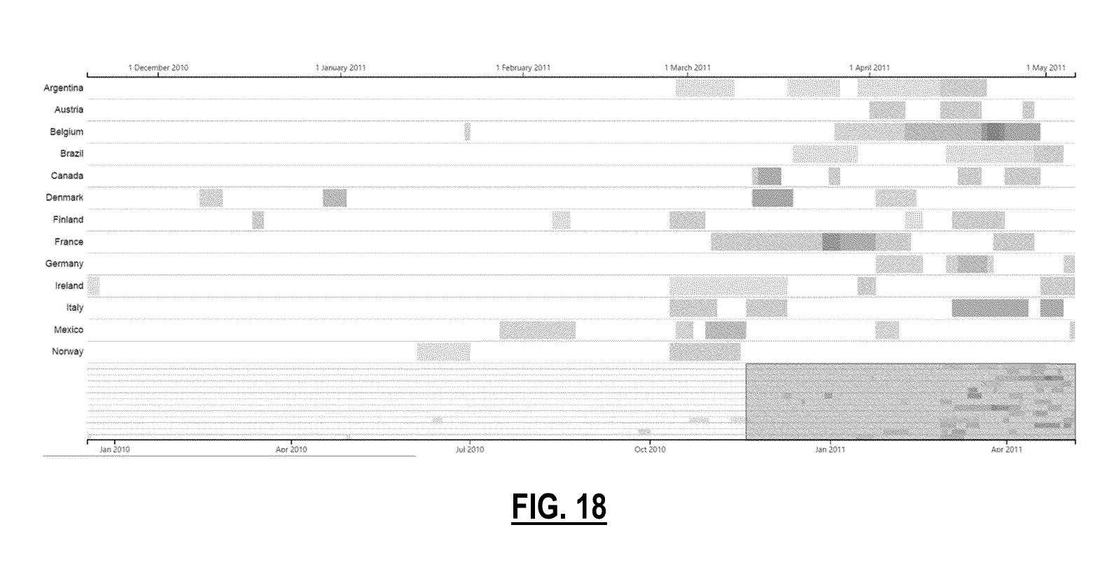

A timeline displays a single metric between two points in time. The length of each item represents the distance between your start and end times. FIG. 18 illustrates an exemplary timeline, and the timeline has
Field 1—Group—This field represents the Y axis.
Field 2—Metric—This field represents the item charted.
Field 3—Datetime—This field represents the beginning point from which the metric will be drawn.
Field 4—Datetime—This field represents the end point to which the metric will be drawn.

A waterfall displays a bar chart with a built in pareto function—that is, the bottom of each bar begins at the top of the previous bar. FIG. 19 illustrates an exemplary waterfall, and the waterfall includes
Field 1—Group—This field represents each bar along the X axis.
Field 2—Metric—This field represents the value of each bar.

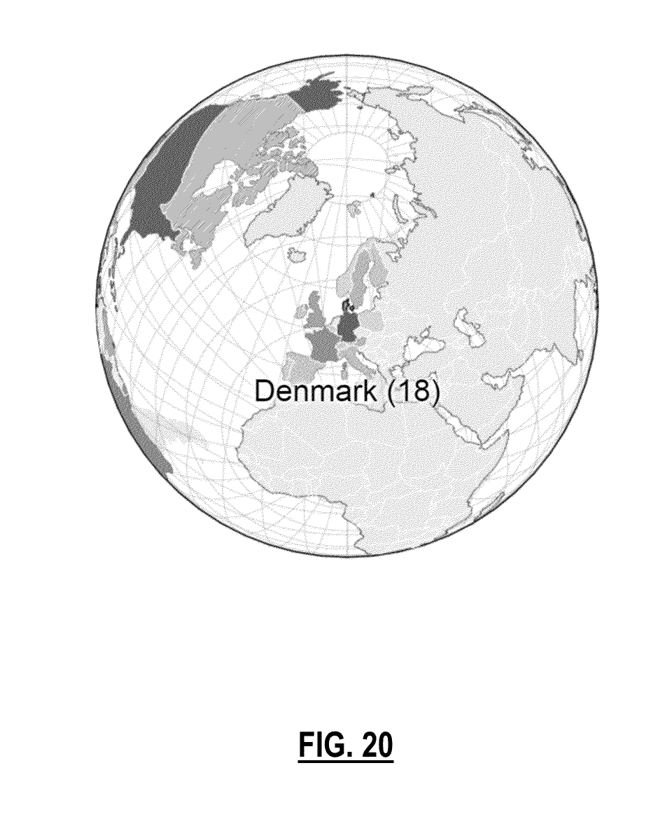

A worldtour visualization displays countries, regions, states, cities, etc. and a single metric associated with that geographic entity. FIG. 20 is an exemplary map for this visualization, shown as a globe, but it could also be any other type of map.
Field 1—Geographical Field—This field represents the geographic entity.
Field 2—Metric—This field represents the value associated with each geographic entity.

### Heuristics

The visualization method 500 utilizes various heuristics to decide how to automatically create a visualization from the selected data. These heuristics enable the “one-click” or “no-click” behavior. In this manner, the visualization method 500 recognizes that there is a vast amount of data that is unreadable to users, and users are typically not experts in how to parse through the data to create visualizations of the data that allow the users to read or better understand the data. The ultimate goal in visual data analytics is to make decisions based on the data. The object of a visualization is to best present the data to a user for the decision making process. The visualization method 500 generally operates on the premises that a user makes a selection of data (through fields), thus the following interactive visualization is most appropriate for the selection of data. The most appropriate visualization is the one that will best help the user visualize and use the data.

The following describe some exemplary heuristics that determine how the visualization method 500 selects the associated visualization. The goal of the heuristics is to operate as a consultant to the user, in the background. Data analytics is a world where users are surprised a lot at the stories told by the data. In this manner, it is not optimal for users to create their own visualizations—here, the user is the author of the story. Rather, the intent with the visualization method 500 is to have the user being a reader of the story.

The heuristics can also include tracking decisions made by previous users on previously created visualizations. For example, if users have chosen pie charts for a certain field 80% of the time for a certain field, then it should pick pie instead of bar based on this. That is, part of the heuristics can be to track what users select—for example, users can manually modify and change the automatically selected visualization. When there is a significant trend, the heuristics can note such preferences for future selection. Thus, the heuristics can include the existing library of reports and visualizations which is used to automate decisions on new visualizations.

Also, the heuristics can include a left to right inference of data hierarchy based on data types. For example, if there are three strings then a date then a number, it infers that the three strings go together like County-State-City even if the names do not imply structure based on heuristics.

These exemplary heuristics are presented from the perspective of when the user selects this data, this visualization is appropriate.

| Selected Data field | Associated Visualization |
|---|---|
| String with countries | Worldmap |
| String with cities in one country | Countrymap (same as Worldmap, |
| | but restricted to one country) |
| Numeric with percentages and | Pie chart |
| one string field | |
| Datetime | Time-based, trend chart |
| Multiple string fields | Heat map |

### Business Intelligence (BI) Users and Ad-Hoc Reporting/Visualization

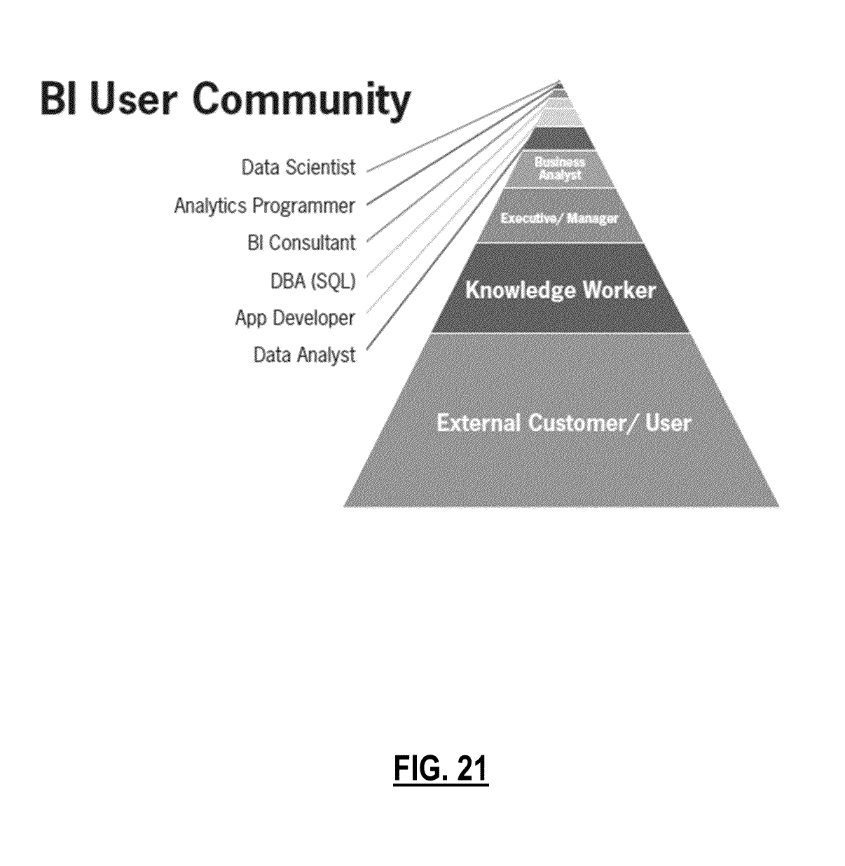

Referring to FIG. 21, in exemplary embodiments, a logical pyramid diagram illustrates types of users for BI systems such as the reporting system 100 and the visualization method 500. In today's business world, more functions in organizations need access to data—and fast. More importantly, every user has a different purpose for the data they want to analyze, visualize and act on. In the past, quarterly responsiveness was acceptable, but today's user requires analysis much faster than that. For example, imagine one wants to order a pizza. If it would take weeks to get it delivered, one would likely cancel the order. Today's user is hungry for data analysis in the same respect, and expects it to be delivered right away. Otherwise, the data analysis is useless.

Typically, the business users that require these reports have read-only versions and the burden to make small changes falls to the engineering and IT departments. Enterprise application developers and product managers know the value of incorporating dashboards or reporting into applications to make this process easier on everybody. An Izenda customer study revealed that over 80% of the requests to engineering could have been avoided with embedded reports and dashboards that offer ad-hoc data exploration capabilities to the users, empowering them to get the reports they need and discover new insights in their data that they may not have known about before. Integrated reporting also enables engineers to focus more on what they do best, with less disruptions, making today's leading tools truly self-service applications.

The BI Evolution in a Self-Service World Takeaway: Traditional BI delivers raw capability, but self-service BI delivers results more readily and gives technical and non-technical users more control. The reporting system 100 and the visualization method 500 fundamentally are self-service BI tools. Business intelligence (BI) involves taking raw data and querying it for patterns, principles and other useful information that would potentially drive value for an organization. This can be from sales transactions, social media or other data sources. While the BI technology industry has been around for more than 40 years, the low cost of storage is driving aggressive growth in the BI and data analysis market. In fact, Gartner reports that the BI market grew to $14.1 billion in 2013 alone and market research firm IDC predicts spending on business analytics will reach $89.6 billion in 2018.

BI is valuable because it enables decision makers at all levels in an organization to leverage data for business advantage—to explore data, draw insights and meaningful conclusions, and make better decisions. This requires a self-service approach that's achieved through embedded BI reports and dashboards that are flexible and user-friendly enough that a marketing or accounting professional can use them without taking up IT or engineering resources.

The reporting system 100 and the visualization method 500 contemplate use with any applications that can embed BI such as Customer relationship management (CRM), Enterprise resource planning (ERP), Financial Apps, Supply Chain Management, Marketing Automation, and the like. IDC research revealed that independent software vendor (ISVs) embed BI because it:
Gives end users better insight into application data;
Improves the application usability with data visualizations and reports;
Reduces custom development of reporting and analytic functionality; and
Beats the competition with more advanced and flexible embedded analytics

Our culture is evolving towards self-service in every form: Google search, Apple products, and now data analysis tools. Notes Jim Kobielus, a Senior Analyst at Forrester Research, “The BI industry saw a continuing trend over the last five years toward more business user-driven data discovery techniques to move analytics beyond traditional methods, making reporting more accessible and pervasive to the new data-driven organization of today.”

Businesses are data-driven, or at least aspire to be that way. Data is more readily available today to more people from a greater variety of sources, such as mobile and social media platforms. The new types of data that have emerged have complicated the analysis process, creating a veritable marketplace of new methods and approaches to analyzing data. BI tools are of course part of this discussion, but making an enterprise more efficient or a small company more competitive is contingent upon a few things:
Can the data be accessed and analyzed fast enough?
Is data analysis reserved for data scientists or is it user-friendly enough for a business user?
Do front-line employees within the organization have flexible tools that allow for exploratory data analysis?
Are the results presentable in a way that communicates what's inside the data?
Do business analysts and users require constant IT support and engineering resources?

While these all seem to be straight forward questions, let's examine the last one a bit further. Business users are becoming more vocal, demanding and influential than ever. Software as a Service solutions now require BI as an integrated feature, because a company cannot function on the same level and capacity as a company that looks at data closely and makes decisions based off of that data.

With conventional BI systems, should a user want to change any reports, or even make slight revisions to existing reports, IT would have to come in and change the data models, then the changes would be approved. This was usually a slow, frustrating process. Every organization has data needs that change quickly, even on a daily basis. Factor in the units within that organization and their unique needs and this is a lot of change requests. Many IT staffs face a growing epidemic of slight—but time-consuming—information requests from BI users, and those users get frustrated when their requests are backlogged. Self-service BI capabilities, from the reporting system 100 and the visualization method 500, free up IT managers from having to spend an inordinate amount of time responding to user requests for new data, new views or updated report formats.

FIG. 21 is a visualization of the growing user community of BI. It is noted that the vast majority of users do not have the expertise to optimally perform BI, i.e. the average users is not a data scientist or IT expert. In that manner, the reporting system 100 and the visualization method 500 are next generation BI tools that empower users in the pursuit of insight to discover what they need on their own path, and free software developers from unnecessary change requests. Again, it is a self-service world. Companies like Apple and Google have helped make this possible by putting powerful tools at the hands of all consumers and making traditionally difficult tasks simple and mainstream. So when today and tomorrow's business users need to create dashboards, it makes sense that they look to flexible applications that allow for them to get what they need in the easiest way possible.

This not only feeds a data-driven organization where better decisions are made, but also inspires more sharing and collaboration. This is can be referred to as “next generation BI,” where new platforms that work with terabytes of data and beyond will expose all of the data to non-technical users such as front-line employees. Technology journalist Elisabeth Horwitt explains, “In addition to reducing the burden on IT and business analysts, self-service BI has increased the quality and consistency of the data and of decisions made with that data.”

These “next generation BI” apps, such as the reporting system 100 and the visualization method 500, are equipped with a flexible and intuitive user interface that is simple to use and yet sophisticated enough to enable the more advanced data analysis that is required for competitive advantage in today's business.

The reporting system 100 and the visualization method 500 include the following to facilitate data analysis:

Flexible Fields—Think back to the days of standard spreadsheet reporting, the main customization function that was critical to self-service reporting was all field-level. However, many applications today still lack the basic functionality of spreadsheet reporting, where users are not able to customize, add or remove fields. To analysts today, these functions are essential. Our study found that the lack of this functionality resulted in dozens of hours of discussion between IT and business users, for really simple capabilities. The demand is there, and embedding these into reporting and dashboarding features within applications is really a requirement. It is not enough to custom build reports, you have to have the capability to add or revise fields, and your reports and dashboards have to change in real-time, and not on a delay based off how busy the IT department is.

To Paginate or Not to Paginate? There is an easy answer to this: Give users the option to do either or both. There's an eternal debate over whether or not the preference is to paginate the reports and dashboards, or to view it all on the same, whole grid. The reporting system 100 and the visualization method 500 found that the best way to make an application user-friendly and thus independent from IT/engineering constant support is to offer the option for both.

With the visualization method 500, seeing is Understanding—Ditch the traditional rows and columns for more appealing, customizable visualizations that help users tell a story. With embedded reporting and dashboards, users can create a wide range of interactive and visually engaging charts and reports, without requiring time-consuming development and without in-depth knowledge of how to create a visualization. Business users today simply don't have the time or the bandwidth for complicated reporting. Developers that embed BI into their applications meet an expectation of analytics that is significant—and growing.

One of the most common concerns is around security: if it's delivered via the cloud then is it secure? Are we sharing data with too many people? The truth is, people tend to be uncomfortable with something as intangible as the cloud because they can't see it, so it's definitely a concern for many but is it a legitimate one. Perhaps, but today's applications can maintain military-grade security and still embed 3rd party reporting and dashboards, i.e., the reporting system 100 and the visualization method 500. For example, even though the reporting system 100 and the visualization method 500 is integrated into an application, it automatically inherits the existing security permissions, e.g., from the databases 110.

Automated Analysis—when users have control over their data, everyone wins. Part of that control includes having the capability to customize automated alerts. Users want to know when things change and they may ask that you manually set these, so either building this functionality into your application or making sure your 3rd party BI provider has this available is important. TDWI outlines these techniques that can be used to automate the handling of BI results:
Alerts where the information consumer is informed via e-mail, instant message, screen message, or highlighting of a result that it is out of bounds and requires action. Such alerts are triggered by business rules that identify thresholds for abnormal results.
Recommendations that extend the concept of alerts by offering suggestions for possible courses of action.
Decision workflows that help information consumers make decisions based on best practices. In some cases, a workflow may identify other sources of information or expertise or further analyses that can be run to aid decision making
Automated actions where decisions and actions are fully automated based on business rules and/or predictive models. Fraud detection and action taking and algorithmic trading are examples of applications here.

Breaking barriers, with the reporting system 100 and the visualization method 500, to data exploration will result in a smarter world, and the intuitive reporting and visualization tools will make analysis user-friendly and thus more mainstream. Business users today simply don't have the time or the bandwidth for complicated reporting. It's not surprising that organizations that make data-driven decisions tend to make better and smarter decisions, and the reporting system 100 and the visualization method 500 can facilitate that. The world's fascination with Big Data and analytics has piqued the interest of a mainstream audience. Developers that embed BI into their applications meet an expectation of analytics that is significant—and growing.

### Reporting System UI and Operations

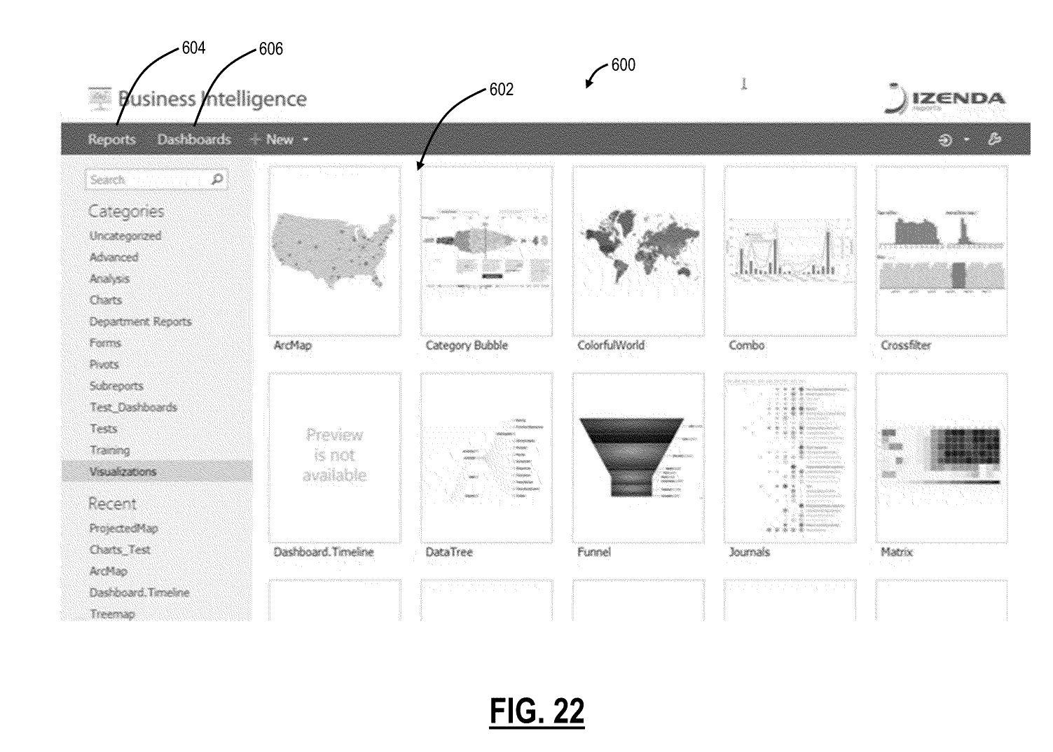

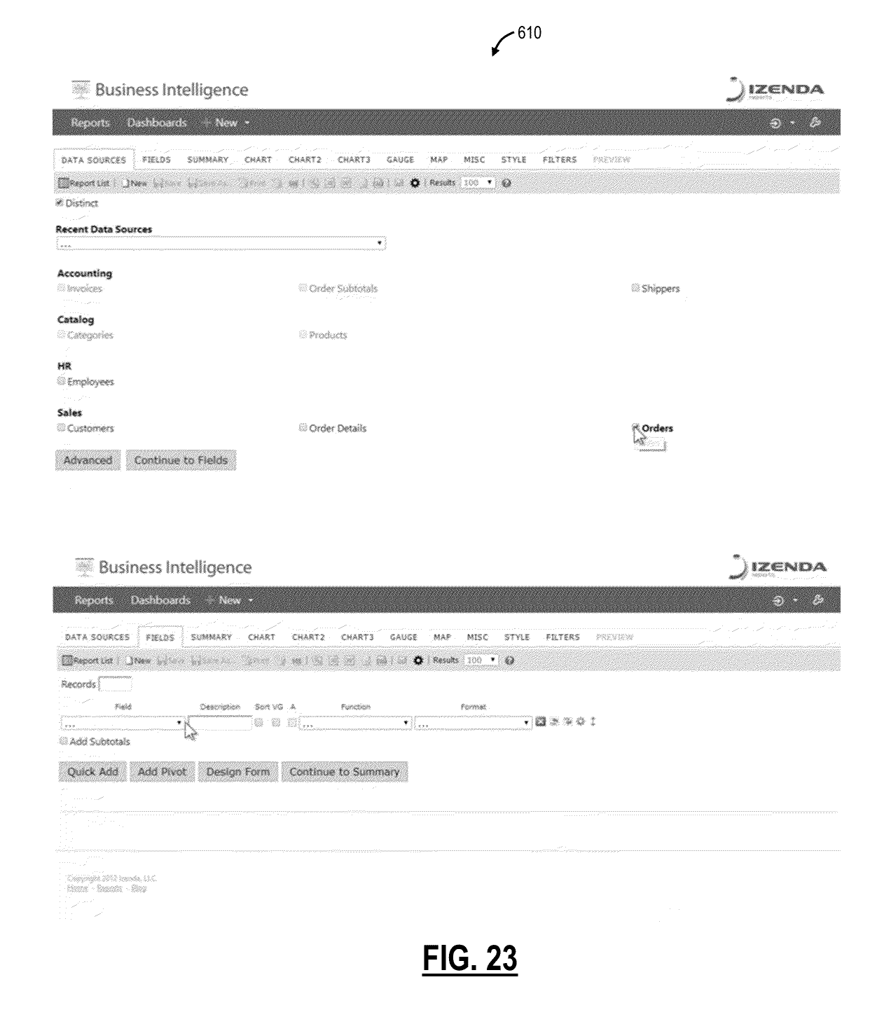

Referring to FIGS. 22-25, in exemplary embodiments, various screenshots illustrate operations of the reporting system 100 and the visualization method 500. In general, the reporting system 100 can include reports and dashboards in a UI 600. FIG. 22 is a UI of various dashboards 602. Note, a user can navigate in the UI 600 between reports 604 and dashboards 606. FIG. 23 is a UI of report screens 610. As described herein, the report screens 610 are provided by the reporting system 100 to the client device 250 enabling an interface between the user and the database 110. In this manner, the user does not have to be an IT expert to prepare a customized report from the database 110, i.e. ad-hoc reporting. Through the report screens 610, the user can select fields for a report—with the visualization method 500, the most appropriate visualization is created from the selected fields. The process of performing an ad-hoc report using the report screens 610 is described in detail in the parent application, U.S. patent application Ser. No. 12/907,184, filed Oct. 19, 2010, and entitled “SELF-SERVICE DATABASE REPORTING SYSTEMS AND METHODS,” the contents of which are incorporated by reference herein.

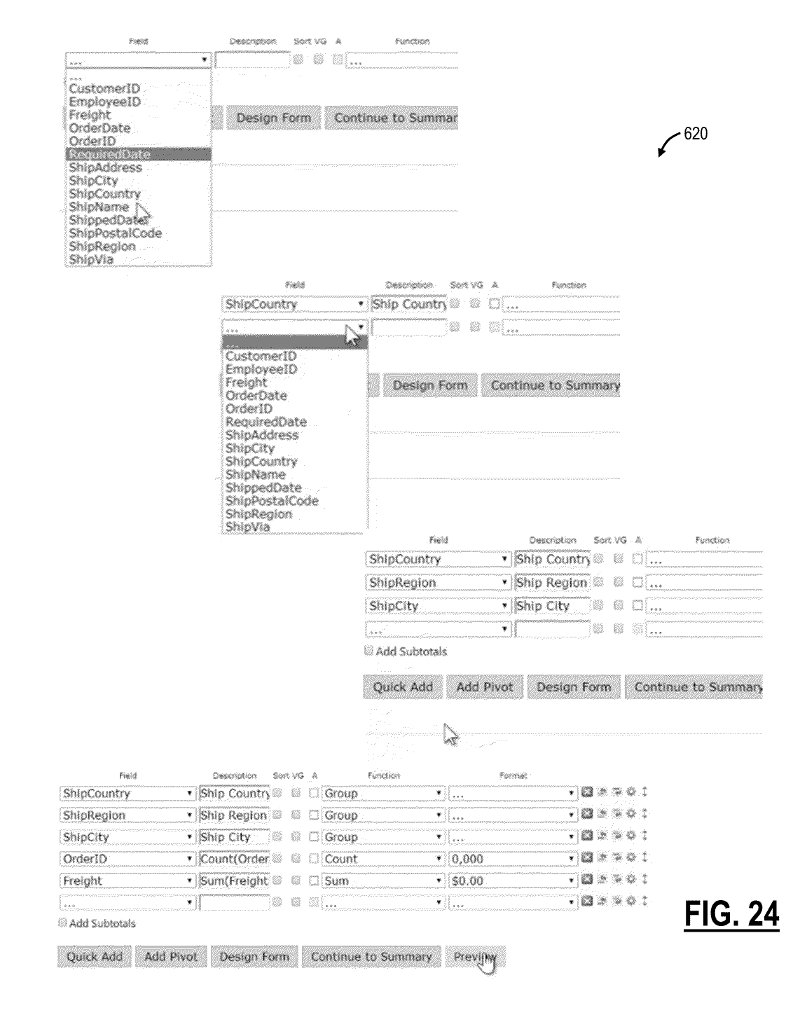

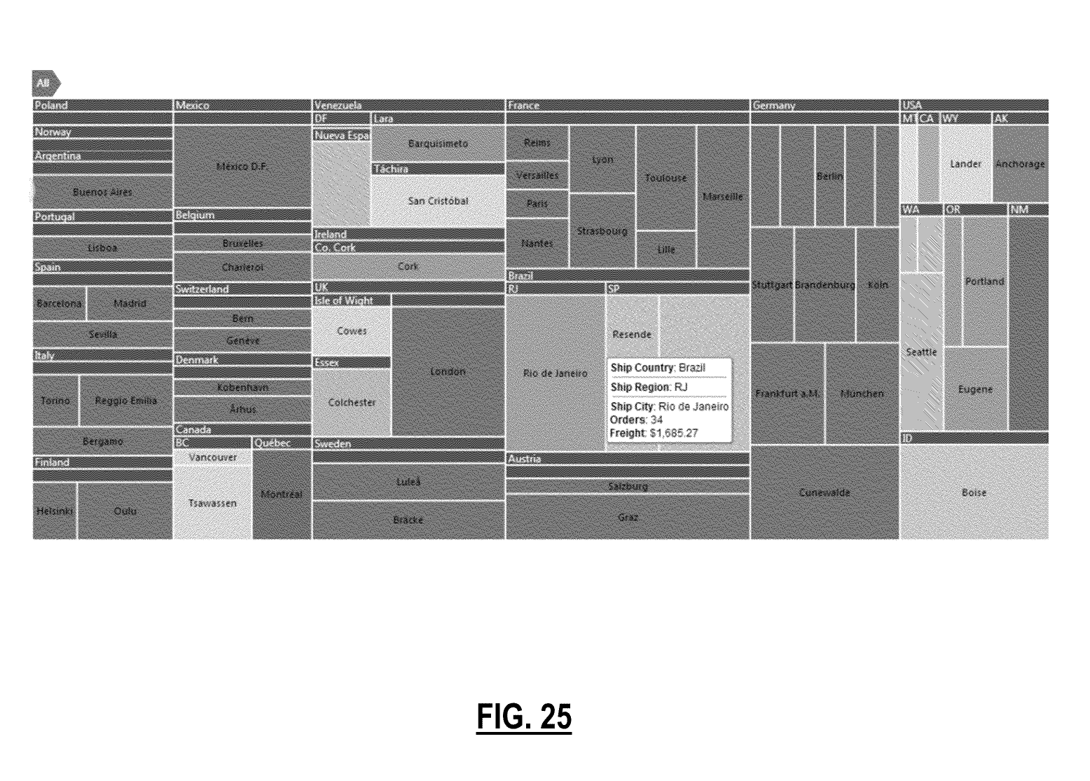

FIG. 24 shows various report screens 620 in the process of adding fields to a custom report. Here, the user has selected fields for Ship country, ship region, ship city, order ID, and freight. Recognizing various string fields, the visualization method 500 creates concurrently a heatmap 630 in FIG. 25. Note, the heatmap 630 is interactive, and the user can now navigate through the selected data from the report, in FIG. 24, visually, using the heatmap 630. Some of the visualizations auto-interpret hierarchies—so start with fields that are related. Here, this is Ship Country, ship region, ship city, order ID, freight. There is a hierarchy to the first few fields. Now, even if the user did not enter the fields in the proper hierarchical order, the visualization method 500 can rearrange the fields to properly provide the heatmap 630.

### Visualization Presentation

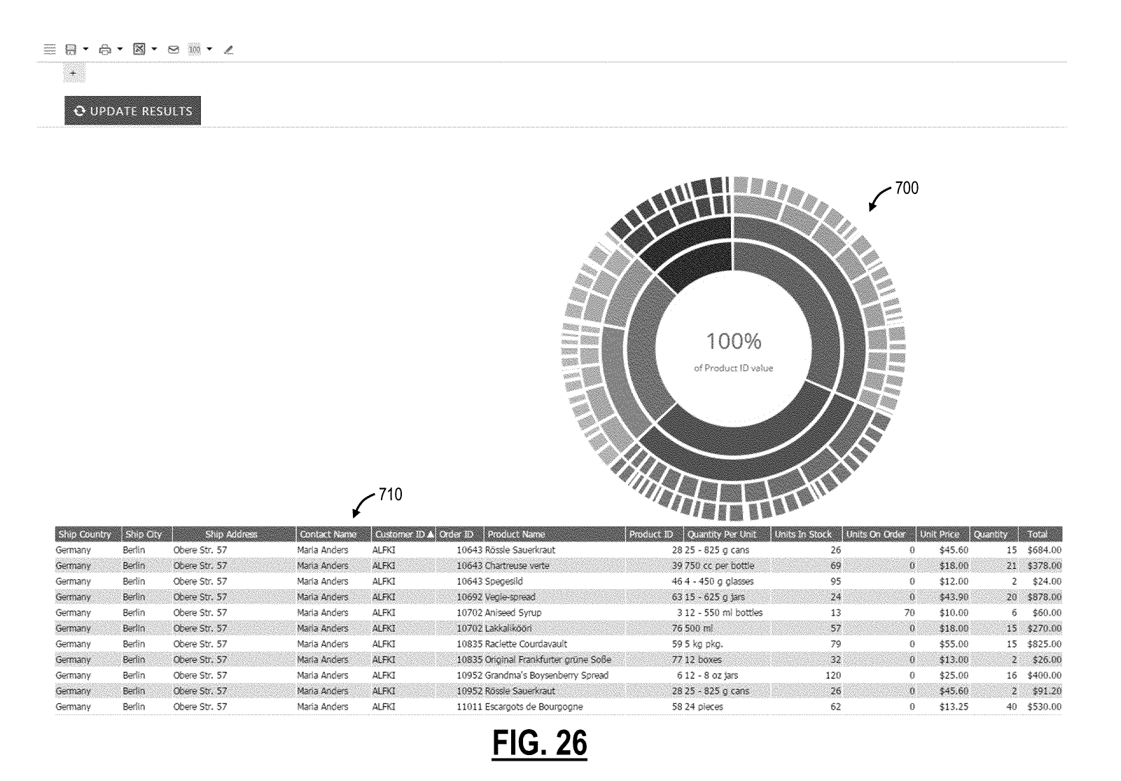

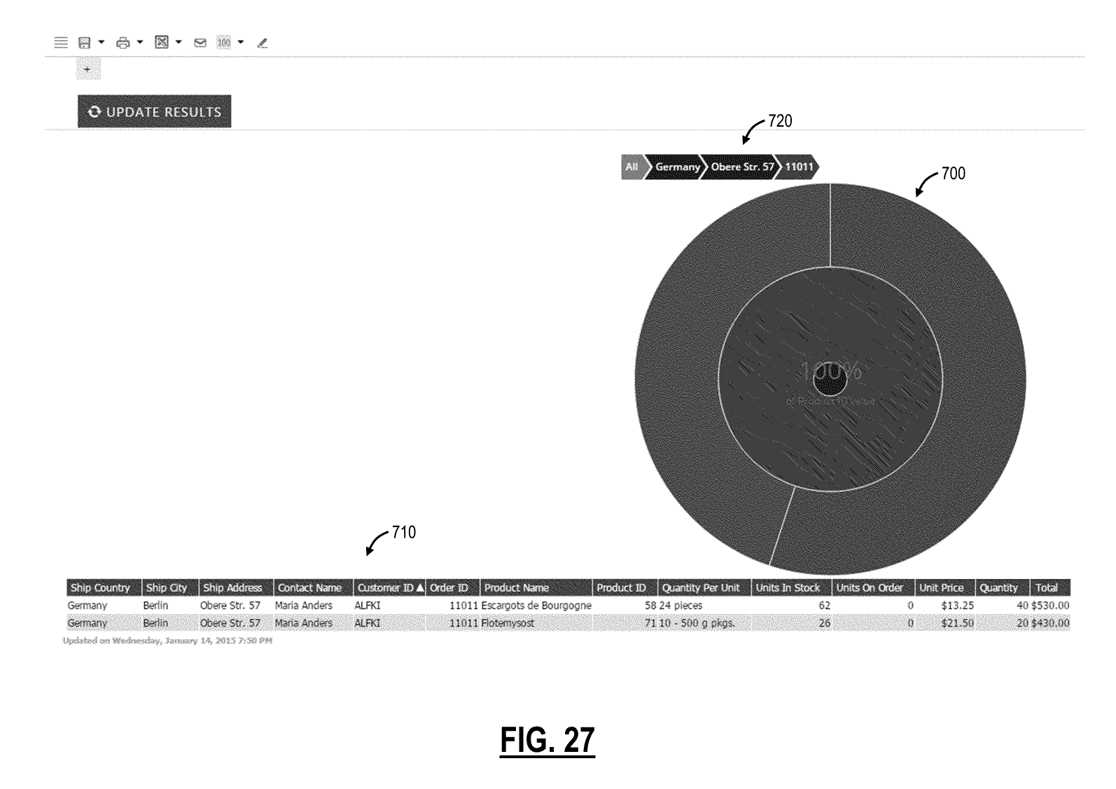

Referring to FIGS. 26 and 27, in an exemplary embodiment, a sunburst 700 visualization is illustrated. FIG. 26 shows a base level—at 100%, and FIG. 27 shows drill-down. Note, each of the sunbursts 700 are displayed with associated grid data 710, i.e., there is an interactive coupling of visualization and grid data and there is automatic interactive visualization of the grid data. Also, note a breadcrumb trail 720 is displayed in the drill-down.

The various visualization screens and accompanying grid data can be rendered using HTML5. Also, the visualization screens can be optimized for desktop or mobile viewing. In case of mobile viewing, where space is a premium, UI elements can be maintained in an unobtrusive manner—e.g., disappear until hovered over.

### JSON-Schema and VALUE Based Abstraction

The reporting system 100 and the associated visualization method 500 can be viewed as operating at three points, as shown in FIG. 3, the client device 250, the server 260, and the database 110. The reporting system 100 is configured to abstract operations in the database 110 from the user, and present a UI to the client device 250. Operations performed in the UI at the client device 250 are translated to SQL or the like to perform data extraction from the database 110. Similarly from a visualization perspective, the reporting system 100 and the associated visualization method 500 utilize JSON schema to create the automatic, interactive visualizations. Here, operations performed by the user at the UI are converted to JSON Schema for creating the visualization. Specifically, some of the visualization code actually runs in the client device 250, via the browser, in an interactive fashion.

With respect to creating visualizations and processing between the client device 250, the server 260, and the database 110, there are multiple levels of aggregation. Some core aggregation is done at the database level but the visualization also does aggregation. So the database 110 might give you the SUM for every city, but then the visualization combines cities into states and countries so it does not need to go back to the database 110 when the user interacts.

It will be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor that, in response to such execution, cause a processor or any other circuitry to perform a set of operations, steps, methods, processes, algorithms, etc.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. An interactive visualization method implemented in a reporting system, the interactive visualization method comprising:
receiving a selection of data through the reporting system, wherein the data is contained in a database with the reporting system interfacing the database;
determining an associated visualization for the selected data based on heuristics, wherein the heuristics are a set of rules used to determine the associated visualization in a manner that is most appropriate for visual analytics given the selected data; and
creating and displaying the associated visualization.

2. The interactive visualization method of claim 1, further comprising:
changing the selected data and/or interacting with the visualization; and
automatically updating the visualization based on the change or interaction.

3. The interactive visualization method of claim 1, wherein the determining and the creating and displaying steps are performed in the reporting system automatically subsequent to a user selecting the selection of data.

4. The interactive visualization method of claim 1, wherein grid data from the selection of data is displayed with the associated visualization, and wherein an interaction with the visualization that causes a change in the visualization also causes a same change in the displayed grid data.

5. An interactive visualization system, comprising:
a network interface coupled to a processor; and
memory storing instructions that, when executed, cause the processor to
obtain a selection of data through the reporting system, wherein the data is contained in a database with the reporting system interfacing the database;
determine an associated visualization for the selected data based on heuristics, wherein the heuristics are a set of rules used to determine the associated visualization in a manner that is most appropriate for visual analytics given the selected data; and
create and cause a display of the associated visualization.

6. The interactive visualization system of claim 5, wherein the memory storing instructions that, when executed, further cause the processor to
detect changes in the selected data and/or an interaction with the visualization; and
automatically update the visualization based on the change or interaction.

7. The interactive visualization system of claim 5, wherein the associated visualization is determined, created, and displayed automatically subsequent to user selection of the data.

8. The interactive visualization system of claim 5, wherein grid data from the selection of data is displayed with the associated visualization, and wherein an interaction with the visualization that causes a change in the visualization also causes a same change in the displayed grid data.

9. An ad-hoc reporting system, comprising:
a network interface coupled to a processor; and
memory storing instructions that, when executed, cause the processor to
present a user interface to a client device for performing an ad-hoc report in a database;
receive a selection of data from the client device;
determine an associated visualization for the selected data based on heuristics, wherein the heuristics are a set of rules used to determine the associated visualization in a manner that is most appropriate for visual analytics given the selected data; and
create and cause a display of the associated visualization on the client device.

10. The ad-hoc reporting system of claim 9, wherein the memory storing instructions that, when executed, further cause the processor to
detect changes in the selected data and/or an interaction with the visualization; and
automatically update the visualization based on the change or interaction.

11. The ad-hoc reporting system of claim 9, wherein the associated visualization is determined, created, and displayed automatically subsequent to user selection of the data.

12. The ad-hoc reporting system of claim 9, wherein grid data from the selection of data is displayed with the associated visualization, and wherein an interaction with the visualization that causes a change in the visualization also causes a same change in the displayed grid data.
